(19) United States
(12) Patent Application Publication
(10) Pub. No.: US 2026/0129556 A1
(43) Pub. Date: May 7, 2026

(54) SIGNALING FOR TRANSMISSION MODES AMONG ACCESS POINTS

(71) Applicant: QUALCOMM Incorporated, San Diego, CA (US)

(72) Inventors: Jialing Li CHEN, San Diego, CA (US); Sameer VERMANI, San Diego, CA (US); Eugene BAIK, Sunnyvale, CA (US); Bin TIAN, San Diego, CA (US); Youhan KIM, Saratoga, CA (US)

(21) Appl. No.: 19/377,271

(22) Filed: Nov. 3, 2025

Related U.S. Application Data
(60) Provisional application No. 63/716,240, filed on Nov. 4, 2024.

(51) Int. Cl. H04W 48/08; H04W 16/14; H04W 16/28

(52) U.S. Cl. CPC H04W 48/08; H04W 16/14; H04W 16/28

(57) ABSTRACT

This disclosure provides methods, components, devices and systems for signaling for transmission modes among access points (APs). Some aspects more specifically relate to signaling and physical layer protocol date unit (PPDU) formats for implementing coordinated communications among multiple APs, such as for one or more transmission modes, which may include a coordinated beamforming (COBF), a coordinated spatial reuse (C-SR), an interference mitigation (IM), or a vendor specific (VS) transmission mode. In some examples, a first AP may transmit first information in a first subset of bits of a universal signal (U-SIG) field, that indicates a transmission mode of the multiple transmission modes associated with a shared transmission opportunity (TXOP). Different subsets of bits within the U-SIG field may indicate the transmission mode of the shared TXOP and one or more associated parameters of one or both of the APs.

### CROSS REFERENCES

The present Application for Patent claims benefit of U.S. Provisional Ser. No. 63/716,240 by CHEN et al., entitled “SIGNALING FOR TRANSMISSION MODES AMONG ACCESS POINTS,” filed Nov. 4, 2024, assigned to the assignee hereof, and expressly incorporated herein.

### TECHNICAL FIELD

This disclosure relates generally to wireless communication and, more specifically, to signaling for transmission modes among access points.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, or an interference mitigation transmission mode and transmitting first information in at least one of a first set of bits of a universal signal (U-SIG) field or one or more bits of a common field of an ultra-high reliability signal (UHR-SIG) of the PPDU, the first information indicating the first transmission mode of the set of multiple transmission modes.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, or an interference mitigation transmission mode and transmit first information in at least one of a first set of bits of a universal signal (U-SIG) field or one or more bits of a common field of an ultra-high reliability signal (UHR-SIG) of the PPDU, the first information indicating the first transmission mode of the set of multiple transmission modes.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, or an interference mitigation transmission mode and means for transmitting first information in at least one of a first set of bits of a universal signal (U-SIG) field or one or more bits of a common field of an ultra-high reliability signal (UHR-SIG) of the PPDU, the first information indicating the first transmission mode of the set of multiple transmission modes.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, or an interference mitigation transmission mode and transmit first information in at least one of a first set of bits of a universal signal (U-SIG) field or one or more bits of a common field of an ultra-high reliability signal (UHR-SIG) of the PPDU, the first information indicating the first transmission mode of the set of multiple transmission modes.

In some examples of the method, first access points, and non-transitory computer-readable medium described herein, the first set of bits of the U-SIG field includes a one bit subfield that indicates whether the first transmission mode may be the coordinated beamforming transmission mode in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or the first set of bits indicates whether the first transmission mode may be the interference mitigation transmission mode in accordance with the PPDU Type And Compression Mode field that indicates a transmission to a single user, and where a second set of bits of the U-SIG field indicates either a first basic service set color of the first access point or a second basic service set color of a second access point for the coordinated beamforming transmission mode, or one or more interference mitigation parameters for the interference mitigation transmission mode, or reserved bits defined as disregard bits or validate bits.

In some examples of the method, first access points, and non-transitory computer-readable medium described herein, the first set of bits of the U-SIG field includes a first bit, and different combinations of bit values of the first bit and a second bit in the U-SIG field or in the common field of the UHR-SIG indicates the first transmission mode may be the coordinated beamforming transmission mode, the coordinated spatial reuse transmission mode, or the interference mitigation transmission mode, and a second set of bits of the U-SIG field, or one or more bits of the common field of the UHR-SIG, indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or may be reserved bits defined as disregard bits or validate bits.

In some examples of the method, first access points, and non-transitory computer-readable medium described herein, the first set of bits of the U-SIG field, or two bits of the common field of the UHR-SIG, includes a two bit subfield that indicates the first transmission mode may be the coordinated beamforming transmission mode, the coordinated spatial reuse transmission mode, or the interference mitigation transmission mode, and where a second set of bits of the U-SIG field or the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or may be reserved bits defined as disregard bits or validate bits.

In some examples of the method, first access points, and non-transitory computer-readable medium described herein, the first set of bits of the U-SIG field includes a first bit that indicates whether one of the set of multiple transmission modes may be enabled, and a second set of bits in the common field of the UHR-SIG indicates the first transmission mode may be the coordinated beamforming transmission mode, the coordinated spatial reuse transmission mode, or the interference mitigation transmission mode, and a third set of bits of the U-SIG field or the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or may be reserved bits defined as disregard bits or validate bits.

In some examples of the method, first access points, and non-transitory computer-readable medium described herein, the first set of bits of the U-SIG field includes a two bit subfield that indicates the first transmission mode may be the coordinated beamforming transmission mode, the coordinated spatial reuse transmission mode, or the interference mitigation transmission mode, and a second set of bits of the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or may be reserved bits defined as disregard bits or validate bits.

In some examples of the method, first access points, and non-transitory computer-readable medium described herein, the first set of bits of the U-SIG field includes first bit that indicates whether a coordinated transmission scheme may be used and second bit that indicates whether coordinated beamforming or coordinated spatial reuse may be used when the first bit indicates the coordinated transmission scheme, and a second set of bits of the U-SIG field indicates either a first basic service set color of the first access point or a second basic service set color of a second access point for the coordinated beamforming or coordinated spatial reuse transmission mode, or an interference mitigation indication and one or more interference mitigation parameters for the interference mitigation transmission mode if the first bit does not indicate the coordinated transmission scheme, or the second set of bits of the U-SIG field may be reserved bits defined as disregard bits or validate bits.

In some examples of the method, first access points, and non-transitory computer-readable medium described herein, the first set of bits of the U-SIG field includes a first bit that indicates whether a physical layer protocol data unit (PPDU) type and compression mode field may be to be interpreted to indicate a transmission mode for the PPDU, where a first value of the first bit indicates that the PPDU type and compression mode field may be to be interpreted according to a first interpretation that indicates an enhanced long range (ELR) transmission mode, and a second value of the first bit indicates that the PPDU type and compression mode field may be to be interpreted to indicate one or more of a non-orthogonal frequency division multiple access coordinated beamforming transmission mode, a single user transmission mode with coordinated spatial reuse, or a single user transmission mode with interference mitigation, and a second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or may be reserved bits defined as disregard bits or validate bits.

Some examples of the method, first access points, and non-transitory computer-readable medium described herein may further include operations, features, means, or instructions for transmitting, in accordance with the first transmission mode being a vendor specific transmission mode, at least one of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within the common field of an ultra-high reliability signal (UHR-SIG) field, or a vendor specific information using one or more bits of subfields within a user field of the UHR-SIG field.

Another innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the first transmission mode including a coordinated beamforming transmission mode or an interference mitigation transmission mode and transmitting a transmission mode indicator in the PPDU, the transmission mode indicator including a first set of bits of a universal signal (U-SIG) field of the PPDU, and transmission mode information in a second set of bits of the U-SIG field, where the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the first transmission mode including a coordinated beamforming transmission mode or an interference mitigation transmission mode and transmit a transmission mode indicator in the PPDU, the transmission mode indicator including a first set of bits of a universal signal (U-SIG) field of the PPDU, and transmission mode information in a second set of bits of the U-SIG field, where the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the first transmission mode including a coordinated beamforming transmission mode or an interference mitigation transmission mode and means for transmitting a transmission mode indicator in the PPDU, the transmission mode indicator including a first set of bits of a universal signal (U-SIG) field of the PPDU, and transmission mode information in a second set of bits of the U-SIG field, where the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the first transmission mode including a coordinated beamforming transmission mode or an interference mitigation transmission mode and transmit a transmission mode indicator in the PPDU, the transmission mode indicator including a first set of bits of a universal signal (U-SIG) field of the PPDU, and transmission mode information in a second set of bits of the U-SIG field, where the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode.

In some examples of the method, first access points, and non-transitory computer-readable medium described herein, at least one of a single bit to indicate interference mitigation may be enabled or disabled, or the one or more interference mitigation parameters, may be indicated in a first portion of the U-SIG field (U-SIG-1) using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

In some examples of the method, first access points, and non-transitory computer-readable medium described herein, a vendor specific transmission mode may be indicated using a one bit indicator in the U-SIG field or a common field of an ultra-high reliability signal (UHR-SIG) that may be different from the transmission mode indicator.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Another innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, an interference mitigation transmission mode, or a vendor specific transmission mode and transmitting a transmission mode indicator in the PPDU, the transmission mode indicator including a first bit and a second bit of a universal signal (U-SIG) field and transmission mode information in a subfield of the U-SIG field, where the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, an interference mitigation transmission mode, or a vendor specific transmission mode and transmit a transmission mode indicator in the PPDU, the transmission mode indicator including a first bit and a second bit of a universal signal (U-SIG) field and transmission mode information in a subfield of the U-SIG field, where the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, an interference mitigation transmission mode, or a vendor specific transmission mode and means for transmitting a transmission mode indicator in the PPDU, the transmission mode indicator including a first bit and a second bit of a universal signal (U-SIG) field and transmission mode information in a subfield of the U-SIG field, where the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, an interference mitigation transmission mode, or a vendor specific transmission mode and transmit a transmission mode indicator in the PPDU, the transmission mode indicator including a first bit and a second bit of a universal signal (U-SIG) field and transmission mode information in a subfield of the U-SIG field, where the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode.

In some examples of the method, first access points, and non-transitory computer-readable medium described herein, the first bit of the U-SIG field indicates whether the coordinated beamforming transmission mode may be enabled or disabled for non-orthogonal frequency division multiple access (non-OFDMA) multi-user (MU) multiple-input multiple-output (MIMO) communications or OFDMA communications, or whether the coordinated spatial reuse transmission mode may be enabled or disabled for single-user (SU) communications.

In some examples of the method, first access points, and non-transitory computer-readable medium described herein, at least one of the second bit of the U-SIG field, or one bit within a first portion of the U-SIG field (U-SIG-1) indicates whether the interference mitigation transmission mode may be enabled or disabled, and when the interference mitigation transmission mode may be enabled, the one or more interference mitigation parameters may be indicated in the U-SIG-1 using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

In some examples of the method, first access points, and non-transitory computer-readable medium described herein, the vendor specific transmission mode may be indicated using a one bit indicator in the U-SIG field or a common field of an ultra-high reliability signal (UHR-SIG) that may be different from the transmission mode indicator.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, vendor specific information using one or more bits within a common field of an ultra-high reliability signal (UHR-SIG), or a vendor specific information using one or more bits of subfields within a user field of an ultra-high reliability signal (UHR-SIG).

Another innovative aspect of the subject matter described in this disclosure can be implemented in a method for wireless communications by a first access point.

The method may include identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and means for transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples of the method, first access points, and non-transitory computer-readable medium described herein, a first bit value of the first set of bits indicates that one or more advanced features for communications may be disabled, a second bit value of the first set of bits indicates that the coordinated beamforming transmission mode may be enabled, a third bit value of the first set of bits indicates that the coordinated spatial reuse transmission mode may be enabled, and a fourth bit value of the first set of bits indicates that the interference mitigation transmission mode may be enabled.

In some examples of the method, first access points, and non-transitory computer-readable medium described herein, the one or more interference mitigation parameters may be indicated in a first portion of the U-SIG field (U-SIG-1) using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

In some examples of the method, first access points, and non-transitory computer-readable medium described herein, a vendor specific transmission mode may be indicated using a one bit indicator in the U-SIG field, or a common field of an ultra-high reliability signal (UHR-SIG), that may be different from the transmission mode indicator.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within an ultra-high reliability signal (UHR-SIG) common field, or a vendor specific information using one or more bits of subfields within a user field of the UHR-SIG field.

Another innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and means for transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits.

In some examples of the method, first access points, and non-transitory computer-readable medium described herein, the one or more interference mitigation parameters may be indicated in a first portion of the U-SIG field (U-SIG-1).

In some examples of the method, first access points, and non-transitory computer-readable medium described herein, a vendor specific transmission mode may be indicated using a one bit indicator in the U-SIG field, or the common field of the UHR-SIG, that may be different from the first set of bits.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within an ultra-high reliability signal (UHR-SIG) common field, or a vendor specific information using one or more bits of subfields within a user field of the UHR-SIG field.

Another innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and means for transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

In some examples of the method, first access points, and non-transitory computer-readable medium described herein, a vendor specific transmission mode may be indicated using a one bit indicator in the U-SIG field or a common field of an ultra-high reliability signal (UHR-SIG) that may be different from the transmission mode indicator.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Another innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, where the first set of bits includes a first bit that indicates whether one of the set of multiple transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, where the first set of bits includes a first bit that indicates whether one of the set of multiple transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and means for transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, where the first set of bits includes a first bit that indicates whether one of the set of multiple transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, where the first set of bits includes a first bit that indicates whether one of the set of multiple transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples of the method, first access points, and non-transitory computer-readable medium described herein, a vendor specific transmission mode may be indicated using a one bit indicator in the U-SIG field or a common field of an ultra-high reliability signal (UHR-SIG) that may be different from the transmission mode indicator.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Another innovative aspect of the subject matter described in this disclosure can be implemented in a method for wireless communications by a first access point. The method may include identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, where the first set of bits includes a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include a processing system that includes processor circuitry and memory circuitry that stores code. The processing system may be configured to cause the first access point to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, where the first set of bits includes a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits.

Another innovative aspect of the subject matter described in this disclosure can be implemented in a first access point for wireless communications. The first access point may include means for identifying a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and means for transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, where the first set of bits includes a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits.

Another innovative aspect of the subject matter described in this disclosure can be implemented in a non-transitory computer-readable medium storing code for wireless communications. The code may include instructions executable by one or more processors to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode and transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, where the first set of bits includes a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits.

In some examples of the method, first access points, and non-transitory computer-readable medium described herein, a vendor specific transmission mode may be indicated using a one bit indicator in the U-SIG field or a common field of an ultra-high reliability signal (UHR-SIG) that may be different from the transmission mode indicator.

Some examples of the method, first access points, and non-transitory computer-readable medium described herein may further include operations, features, means, or instructions for transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a pictorial diagram of an example wireless communication network in which APs use coordinated resources for communications with one or more associated STAs.

FIG. 5 shows an example of U-SIG and UHR-SIG common fields of a PPDU that support signaling for transmission modes among APs.

FIGS. 6 through 10 show examples of U-SIG fields of a PPDU that support signaling for transmission modes among access points.

FIG. 11 shows examples of PPDU Type And Compression Mode subfields that may have different interpretations that support signaling for transmission modes among APs.

FIG. 12 shows an example of a U-SIG field of a PPDU that supports signaling for transmission modes among access points.

FIG. 13 shows examples of PPDU Type And Compression Mode subfields that may have different interpretations that support signaling for transmission modes among APs.

FIG. 14 shows an example of a U-SIG field of a PPDU that supports signaling for transmission modes among access points.

FIG. 15 shows an example of UHR-SIG common fields of a PPDU that support signaling for transmission modes among APs.

FIG. 16 shows a block diagram of an example wireless communication device that supports signaling for transmission modes among access points.

FIGS. 17 through 24 show flowcharts illustrating example processes performable by or at a first access point that supports signaling for transmission modes among access points.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless communications devices may use one or more different transmission modes for transmission of physical layer (PHY protocol data units (PPDUs). For example, two or more access points (APs) may coordinate resources for a transmission opportunity (TXOP). Coordination of the resources may include a first AP (which may be referred to as a sharing AP), and a second AP (which may be referred to as a shared AP), exchanging messages associated with the coordination of the resources and STAs that are to be scheduled by one or more of the first and the second AP for communications during the TXOP. Further, one or more transmission modes may be implemented by the wireless communication devices to reduce interference between communications by the sharing and the shared APs and respective STAs. For example, a coordinated beamforming (COBF) transmission mode may leverage hardware capabilities of an AP to null signals directed to overlapping basic service set (OBSS) STAs scheduled by another AP during the TXOP. A coordinated special reuse (C-SR) transmission mode may rely on isolation between respective APs and STAs to coordinate resources and transmit power control, rather than actively nulling signals. An interference mitigation (IM) transmission mode may rely on processing at a receiving device to filter out one or more interfering signals. Additionally, or alternatively, a vendor specific (VS) transmission mode may implement a transmission mode in which APs and STAs that are provided by a same company or operate using one or more techniques configured by the company (such as proprietary hardware and/or signal processing techniques). With multiple different transmission modes that may be available for communications, it may be beneficial for an AP to signal a transmission mode and one or more related parameters in a PPDU for communications with one or more STAs.

Various aspects relate generally to a signaling and PPDU formats for enabling communications among multiple APs, such as for the COBF transmission mode, the C-SR transmission mode, the IM transmission mode, and/or the VS transmission mode. Some aspects more specifically relate to AP communications that facilitate the communications using C-SR, COBF, IM, and/or VS communications. In accordance with various aspects, C-SR, COBF, IM, and/or VS may be referred to as advanced features, and various techniques discussed herein relate to signaling for such advanced features. In some implementations, a first AP may transmit first information in a first set of bits of a universal signal (U-SIG) field of a PPDU, or one or more bits of a common field of an ultra-high reliability signal (UHR-SIG) of the PPDU, that indicates a transmission mode of the multiple transmission modes. In some implementations, the first information may indicate whether COBF or C-SR is on or off, and in the case of this technique is OFF, it may be indicated whether the IM transmission mode is on or off. Additionally, or alternatively, there may be an indication in a PPDU of whether the VS transmission mode is on or off, and optionally one or more parameters associated with the IM transmission mode.

In some implementations, the first set of bits of the U-SIG field, or the one or more bits of a common field of the UHR-SIG, may include a one bit subfield that indicates the transmission mode is the COBF transmission mode in accordance with an uplink/downlink bit and a PPDU Type And Compression Mode field that jointly indicate a non-OFDMA MU MIMO transmission or an OFDMA transmission, or the first set of bits indicates whether the first transmission mode is the interference mitigation transmission mode in accordance with the PPDU Type And Compression Mode field that indicates a transmission to a single user, and a second set of bits of the U-SIG field may indicate either a first basic service set (BSS) color of the first AP or a second BSS color of a second AP for the COBF transmission mode or the C-SR transmission mode, or one or more IM parameters for the IM transmission mode. In some implementations, the first set of bits of the U-SIG field may include a one bit subfield that indicates the COBF transmission mode, regardless of the values in the UL/DL subfield and the PPDU Type And Compression Mode subfield, and a second set of bits of the U-SIG field may indicate a first BSS color of the first AP or a second BSS color of the second AP for the COBF transmission mode. In some cases, when the first set of bits of the U-SIG field includes a one bit subfield that indicates the PPDU is not in the COBF transmission mode, a second subset of bits of the U-SIG field or UHR-SIG common field may indicate the IM transmission mode and/or one or more IM parameters for the IM transmission mode. In some implementations, the first set of bits of the U-SIG field may include two non-adjacent bits where different combinations of values of the two bits indicate the COBF, C-SR, or IM transmission mode, and a second set of bits of the U-SIG field indicates a BSS color of the first and/or second AP for the COBF or C-SR transmission mode, or one or more IM parameters for the IM transmission mode. In some implementations, the first set of bits of the U-SIG field is a two bit subfield with two adjacent bits, that indicates the COBF, C-SR, or IM transmission mode, and a second set of bits of the U-SIG field indicates a BSS color of the first and/or second AP for the COBF or C-SR transmission mode, or one or more IM parameters for the IM transmission mode. In some aspects, an indication bit definition or interpretation depends on the transmission mode of the PPDU, which may be determined according to a combination of an UL/DL subfield and PPDU Type And Compression Mode subfield.

In some implementations, the first subset of bits of the U-SIG field may include a coordinated transmission scheme indication and a COBF/C-SR indication bit that indicates whether COBF or C-SR is used when the coordinated transmission scheme indication indicates coordinated transmissions, and a second subfield of the U-SIG field indicates a BSS color of the second AP for the COBF or C-SR transmission mode. In some implementations, an IM indication and one or more IM parameters for the IM transmission mode may be provided in the second subfield if the coordinated transmission scheme indication does not indicate coordinated transmissions. In some implementations, the first subset of bits of the U-SIG field may include a one bit subfield that indicates whether a PPDU Type And Compression Mode field is to be interpreted to indicate a transmission mode for the shared TXOP, where a first value of the one bit subfield indicates that the PPDU Type and Compression Mode subfield is to be interpreted according to a legacy interpretation and a second value of the one bit subfield indicates that the PPDU Type and Compression Mode subfield is to be interpreted to indicate uplink/downlink enhanced long range (ELR), downlink non-OFDMA COBF, downlink single user (SU) C-SR, and/or downlink IM (SU or OFDMA). In some aspects, after the indication of an advanced feature, some information related to the advanced feature may be carried in a UHR-SIG field as well. For example, some information, including the indication of one or more advanced features may be carried in UHR-SIG common field. Information related to an advanced feature in SU transmissions may be carried in UHR-SIG common field, information related to an advanced feature and common to all users in non-OFDMA MU-MIMO or DL OFDMA transmissions may be carried in a UHR-SIG common field, and/or information related to an advanced feature and specific to each user may be carried in the user fields in UHR-SIG.

Additionally, or alternatively, the first subset of bits may indicate a transmission mode and the second subset of bits may provide transmission mode information in the PPDU. In some implementations, the first set of bits may include a first bit that indicates whether one of two or more of the transmission modes is enabled, and a third set of bits in the common field of the UHR-SIG may indicate the enabled transmission mode is the COBF transmission mode, the C-SR transmission mode, or the IM transmission mode. In some implementations, the second set of bits may indicate either a BSS color of the first and/or second AP for the COBF transmission mode or the C-SR transmission mode, one or more IM parameters for the IM transmission mode, or are reserved bits defined as disregard bits or validate bits. In some implementations, the first set of bits may include a two bit subfield that indicates the COBF transmission mode, the C-SR transmission mode, or the IM transmission mode, the second set of bits may indicate either a BSS of the first and/or second AP for the COBF transmission mode or the C-SR transmission mode, or one or more IM parameters for the IM transmission mode, and a third set of bits may indicate one or more IM parameters for the IM transmission mode, or are reserved bits defined as disregard bits or validate bits.

Additionally, or alternatively, the first AP and second AP may communicate in accordance with a VS transmission mode, and the first AP may transmit a vendor specific field subsequent to the U-SIG field that indicates one or more vendor specific parameters. In some implementations, the vendor specific field may be included within an ultra-high reliability signal (UHR-SIG) field that indicates one or more vendor specific parameters. In some implementations, the vendor specific field may provide vendor specific information using one or more bits or subfields within a UHR-SIG common field. Additionally, or alternatively, the first AP and second AP may communicate in accordance with a VS transmission mode, and the first AP may repurpose some bits or subfields within U-SIG, UHR-SIG common field, or user fields in UHR-SIG to convey vendor specific information. In some implementations, the interpretation of at least one of the VS indication, the vendor specific field, or vendor specific information conveyed via repurposing one or more subfields within U-SIG, UHR-SIG common field or user fields in UHR-SIG may depend on at least one of the vendor, capabilities of the AP and non-AP STAs that belong to the same vendor to perform certain techniques, PHY version of the PPDU (as indicated in the PHY version identifier), PPDU bandwidth (as indicated in the bandwidth field), communication direction (as indicated in the UL/DL subfield), PPDU type and compression mode (as indicated in the PPDU Type And Compression Mode subfield), or advanced feature (such as COBF, CSR or IM) or no advanced feature. Further, the interpretation of at least one of the VS indication, the vendor specific field, or vendor specific information conveyed via repurposing one or more subfields within U-SIG, UHR-SIG common field or user fields in UHR-SIG may depend on at least one of the size of a certain RU or multiple RU (MRU), the number of users assigned in a certain RU or MRU, the total number of spatial streams (Nss, total) assigned to one or more users in a certain RU or MRU, number of spatial streams (Nss) for a certain user, coding type (BCC or LDPC) for a certain user, advanced LDPC coding technique (2× LDPC) for a certain user, modulation and coding scheme (MCS) for a certain user, beamformed or non-beamformed transmission for a certain user, or equal modulation (EQM) or unequal modulation (UEQM) in spatial domain being used for a certain user in the case of more than one spatial stream being assigned to the user.

Particular aspects of the subject matter described in this disclosure can be implemented to realize one or more of the following potential advantages. In some implementations, by using the signaling framework for facilitating the indication of a transmission mode and one or more parameters of multiple different transmission modes, the wireless communication devices may be able to efficiently signal and utilize the transmission mode that supports communications in accordance with current conditions between the wireless communications devices and capabilities of the wireless communications devices. Additionally, some transmission modes may provide greater communication performance and reliability, provided that operating conditions are suitable for those transmission modes, and particular aspects of the subject matter described in this disclosure facilitate signaling of the transmission mode that suits a current operating condition. Further, signaling of parameters for concurrent communications may facilitate enhanced reception and processing of communications of PPDUs that are transmitted by multiple APs. In accordance with achieving such mode selection and utilization of a transmission mode, the described techniques can be further implemented to realize higher data rates, greater spectral efficiency, improved latency, and greater system capacity, among other benefits.

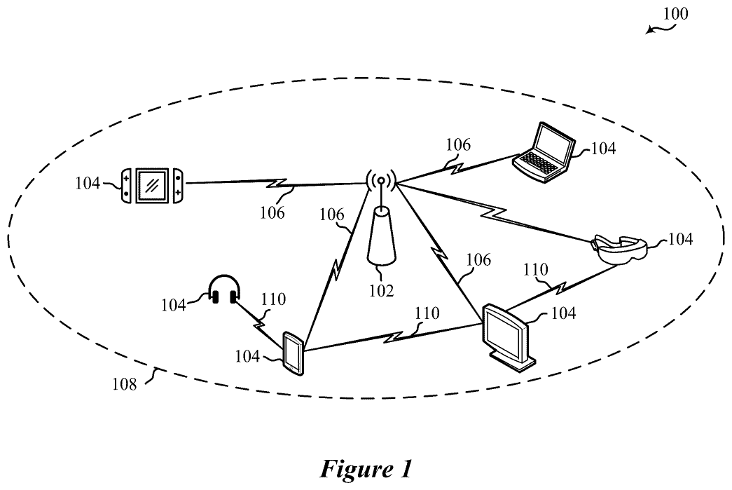

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102.

FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

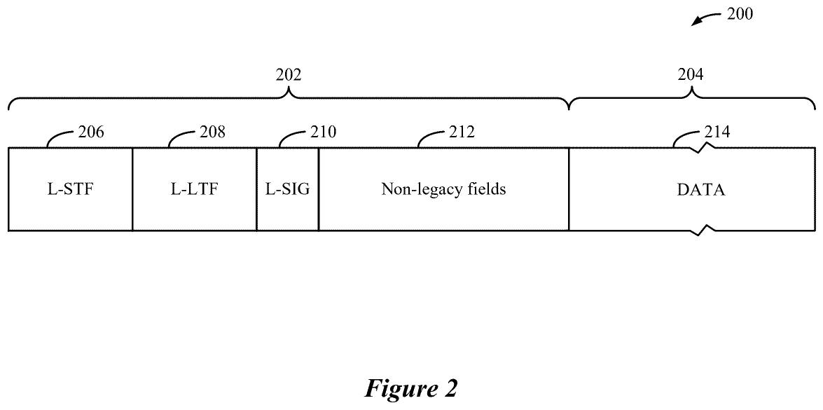

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel.

The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

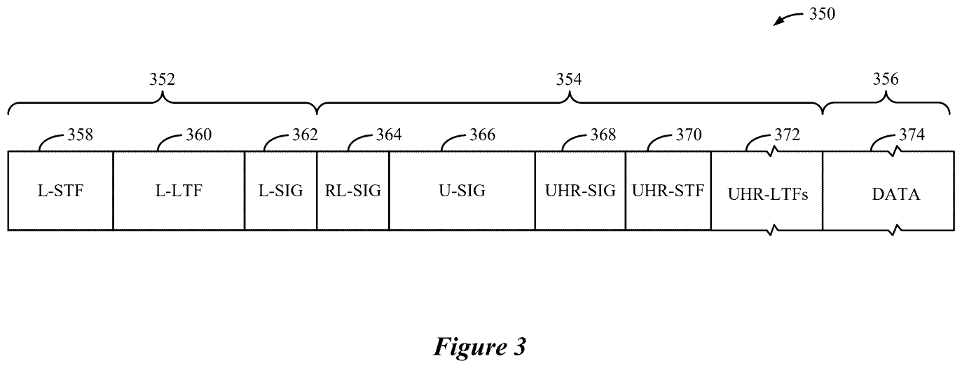

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signal (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

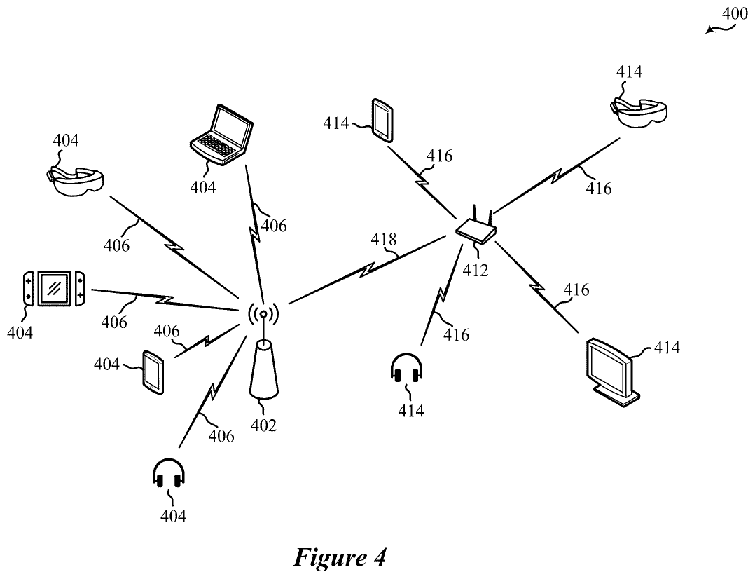

FIG. 4 shows a pictorial diagram of another example wireless communication network 400. According to some aspects, the wireless communication network 400 can be an example of a network in accordance with one or more of the IEEE 802.11 family of wireless communication protocol standards. The wireless communication network 400 may include multiple wireless communication devices, which in some implementations may include a first AP 402, a second AP 412, a first set of STAs 404 that communicate with the first AP 402 via communication links 406, and a second set of STAs 414 that communicate with the second AP 412 via communication links 416. The communication links 406 and the communication links 416 may be examples of communication links 106, the first AP 402 and second AP 412 may be examples of APs 102, and STAs of the first set of STAs 404 and the second set of STAs 414 may be examples of STAs 104 discussed with reference to FIG. 1-3. In some aspects, the first AP 402 and the second AP 412 may communicate via communication link 418, which may be an example of a Wi-Fi link or communication link 106 as discussed with reference to FIG. 1-3. The example wireless communication network 400 illustrates example operations and signaling for coordinated communications among the first AP 402 and the second AP 412 in a shared TXOP. It is noted that in some situations, the roles of the APs may swap if the TXOP holder changes. While various examples discussed herein may reference the first AP 402 as having the role of the sharing AP and the second AP 412 as having the role of the shared AP, it is to be understood that such roles may swap, and various techniques discussed herein may be used in such situations.

As described herein, the wireless communication devices, such as first AP 402, second AP 412, and STAs of the first set of STAs 404 or the second set of STAs 414, may implement a coordinated communications within shared TxOPs, such as by using COBF, C-SR, and/or IM transmission modes. In some aspects, additionally or alternatively, a VS transmission mode may be implemented. In some aspects, the first AP 402 and the second AP 412 may exchange one or more messages related to the coordinated communications. The transmission modes may be used to determine when to share resources among APs and when not to share such resources, and how to share resources among APs, with spatial nulling (in the COBF mode), only with transmit power control but no spatial nulling (in the C-SR mode), or with IM processing (in the IM mode). Additionally, or alternatively, transmission modes may be used to determine vendor specific processing or procedures for communications in the shared TXOP (in the VS mode). In some aspects, signaling to indicate the COBF transmission mode of a shared TXOP may be provided in U-SIG in a PPDU, such as a UHR MU PPDU. In some aspects, a pre-UHR portion of a preamble may be identical across the first AP 402 and the second AP 412, and the U-SIG may include an indication of both the BSS color of the first AP 402 (which may be a sharing AP) and that of the second AP 412 (which may be a shared AP). In some aspects, the first AP 402 and the second AP 412 may differentiate the per-user SIG field, such as with a 1-bit field in the per-user SIG field to differentiate between the two APs.

In some aspects, for the C-SR transmission mode, there may be no synchronization or alignment of PPDUs, and a TXOP duration may be announced in a preceding frame, such as a C-SR invite or C-SR trigger frame. In some aspects, for the C-SR transmission mode, start and end times for PPDUs may be the same for both of the first AP 402 and the second AP 412, and in some implementations the TXOP duration may be announced in preceding frames (such as a trigger or invite frame). In some aspects, for the C-SR transmission mode, PPDUs may share a common preamble until L-SIG, which may make it easier for third party receivers to decode L-SIG and understand the PPDU duration through the Length field in L-SIG. In some aspects, for the C-SR transmission mode, PPDUs may share a common preamble until U-SIG, which may make it easier for third party EHT/UHR/beyond receivers to decode U-SIG and understand the version independent information. In further aspects, for the C-SR transmission mode, PPDUs may share a common preamble until UHR-SIG, which may further ensure per-BSS signaling correctness. In still further aspects, for the C-SR transmission mode, PPDUs may share a common preamble until UHR-LTF (joint LTF), which may further allow possible estimate of OBSS interfering channel and interference mitigation if a spatial dimension allows. In some implementations, if two PPDUs share a common preamble until at least U-SIG, an indication of the C-SR transmission mode may be provided in U-SIG or the UHR-SIG common field, and BSS colors may be indicated, as with the COBF transmission mode. In some implementations, if two PPDUs further share the same UHR-SIG, differentiation of APs may be provided, such as in the per-user SIG field, as with the CoBF transmission mode. In some aspects, C-SR may be used for SU transmissions, and the C-SR indication and signaling may depend on the SU transmission mode.

In some aspects, for the IM transmission mode, it may be assumed IM is for SU transmissions only, or that IM is on or off for all users in OFDMA or non-OFDMA MU-MIMO transmissions. In some implementations, the IM transmission mode may be applicable to both MU PPDUs and trigger frames for trigger based (TB) PPDUs. For the IM transmission mode, the first AP 402 may indicate the following in U-SIG or UHR-SIG common field: an IM transmission, one or more IM mode operation parameters (such as information about quantity, location, periodicity, etc., of pilots or other such IM mechanisms) if not fixed, and a 1-bit signaling for a receiver to request the transmitter to enable the IM mode in subsequent packets. In some implementations, the first AP 402 may indicate the IM transmission or IM mode operation parameters in a common information field, or a special user information field in a trigger frame for UHR.

In some aspects, for the VS transmission mode, it may be assumed that VS is for SU transmission only, or that the VS transmission mode is on or off for all users in downlink OFDMA or non-OFDMA MU-MIMO transmissions. In a multi-AP coordination scheme, such as COBF or CSR associated with two APs, it may be assumed that VS is for the only user or all users serving by one AP in the coordinated transmission, such as the COBF or CSR transmission mode. In some aspects, different BSSs can have their own VS indication and VS field or signaling, or they may share all of them if associated APs and all STAs belong to the same vendor. In some aspects, the VS transmission mode indication and vendor specific information may be carried in one or more of the following locations: a VS field after U-SIG, certain reserved bits or subfields within U-SIG, a VS field after UHR-LTF and before the Data field, bits (B11-B15) in a service field in the data field, padding bits in UHR-SIG, a VS field after UHR-SIG in the MU PPDU, a VS subfield within UHR-SIG in the MU PPDU, or certain reserved bits or subfields within a UHR-SIG common field in the MU PPDU. In some implementations, the VS transmission mode may be enabled or disabled independently from other transmission modes, or may be enabled only when the C-SR, COBF, and IM transmission modes are disabled. Additionally, or alternatively, the first AP and second AP may communicate in accordance with a VS transmission mode, and the first AP may repurpose some bits or subfields within U-SIG, UHR-SIG common field, or user fields in UHR-SIG to convey vendor specific information. In some implementations, the interpretation of at least one of the VS indication, the vendor specific field, or vendor specific information conveyed via repurposing one or more subfields within U-SIG, UHR-SIG common field or user fields in UHR-SIG may depend on at least one of the vendor, capabilities of the AP and non-AP STAs that belong to the same vendor to perform certain techniques, PHY version of the PPDU (as indicated in the PHY version identifier), PPDU bandwidth (as indicated in the bandwidth field), communication direction (as indicated in the UL/DL subfield), PPDU type and compression mode (as indicated in the PPDU Type And Compression Mode subfield), or advanced feature (such as COBF, CSR or IM) or no advanced feature. Further, the interpretation of at least one of the VS indication, the vendor specific field, or vendor specific information conveyed via repurposing one or more subfields within U-SIG, UHR-SIG common field or user fields in UHR-SIG may depend on at least one of the size of a certain RU or multiple RU (MRU), the number of users assigned in a certain RU or MRU, the total number of spatial streams (Nss, total) assigned to one or more users in a certain RU or MRU, number of spatial streams (Nss) for a certain user, coding type (BCC or LDPC) for a certain user, advanced LDPC coding technique (2× LDPC) for a certain user, modulation and coding scheme (MCS) for a certain user, beamformed or non-beamformed transmission for a certain user, or equal modulation (EQM) or unequal modulation (UEQM) in spatial domain being used for a certain user in the case of more than one spatial stream being assigned to the user.

In accordance with various aspects, joint signaling of transmission modes may be provided, which may allow for efficient use of signaling resources, such as one or more fields in a PPDU preamble, such as U-SIG and UHR-SIG. In some implementations, the CoBF, C-SR and IM transmission modes may target different OBSS interference scenarios, and may be mutually exclusive such that one such advanced feature may be enabled at any given time. In some implementations, when using one of these transmission modes, spatial reuse may be disabled, and a spatial reuse field (such as in UHR-SIG common) may be set to a fixed value to prohibit spatial reuse or repurposed to convey other information. Further, in some implementations, a UHR-SIG MCS may be fixed to a certain MCS such as MCS0, and thus the UHR-SIG MCS field may be set to a fixed value or repurposed to convey other information. Additionally, CoBF may be for non-OFDMA MU-MIMO transmissions and/or downlink OFDMA transmission, and C-SR and IM may be for SU transmissions only. The number of non-OFDMA users field of UHR-SIG common in the case of SU transmissions may be repurposed to convey other information.

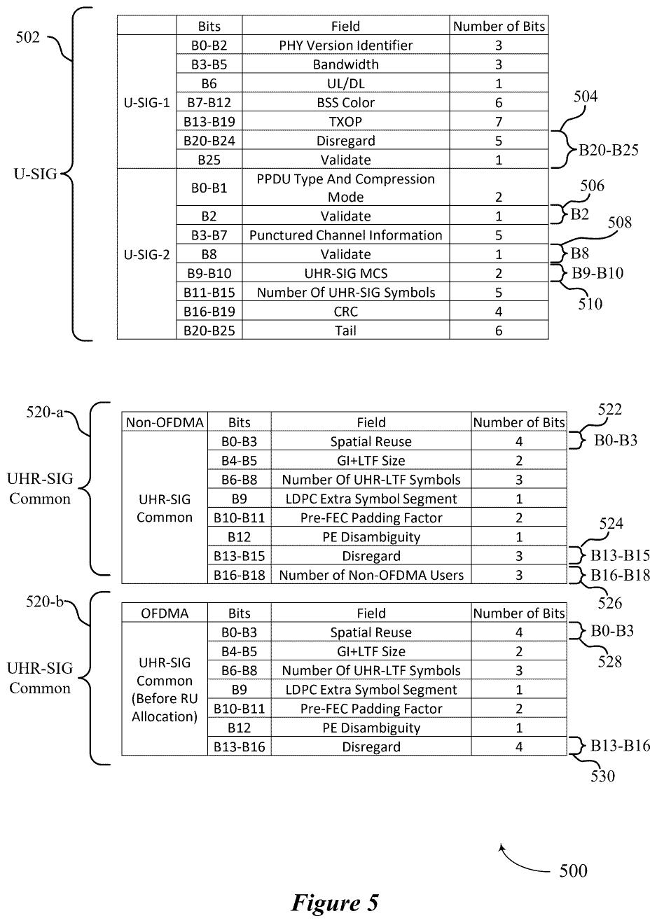

Based on such transmission characteristics of the COBF, C-SR, IM, and VS transmission modes, different fields of U-SIG, and UHR-SIG common, may be repurposed to indicate information related to the COBF, C-SR, IM, and/or VS transmission mode. Further, in some implementations, one or more Disregard or Validate bits within the U-SIG and/or UHR-SIG common may be used to indicate information related to the COBF, C-SR, IM, and/or VS transmission mode. Examples of information in U-SIG and/or UHR-SIG common fields that may be used to indicate information related to the COBF, C-SR, IM, and/or VS transmission mode are discussed with reference to FIGS. 5 through 11.

FIG. 5 shows an example of U-SIG and UHR-SIG common fields of a PPDU 500 that supports signaling for transmission modes among access points. In this example, U-SIG 502 and UHR-SIG common 520 fields are illustrated, which may be transmitted by an AP to one or more STAs in accordance with a transmission mode in which each AP may communicate with one or more STAs. The APs and STAs may be examples of the APs and STAs as described herein with respect to FIG. 1-4. The U-SIG 502 and UHR-SIG common 520 fields (including UHR-SIG common 520-a for non-OFDMA and UHR-SIG common 520-b for OFDMA) illustrate example signaling for indication of the COBF, C-SR, IM, and/or VS transmission modes. As shown in FIG. 5, the U-SIG 502 may include two portions, U-SIG-1 and U-SIG-2, in accordance with existing specifications, and the UHR-SIG common field may use a UHR-SIG common field format for non-OFDMA communications and a UHR-SIG common field format for OFDMA communications.

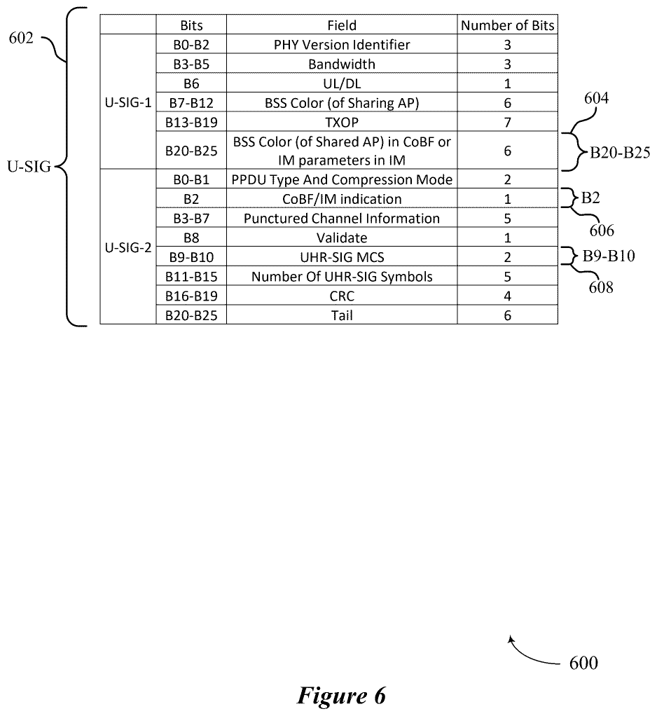

As described herein, the wireless communication devices may implement a framework for selection and utilization of a transmission mode from a COBF transmission mode, a C-SR transmission mode, an IM transmission mode, and/or a VS transmission mode. The transmission modes may be used to determine when and how to share resources with other APs and when not to share such resources. In some implementations, one or more subfields of U-SIG 502, or UHR-SIG common 520-a or UHR-SIG common 520-b, may be used to indicate the transmission mode for a shared TXOP, and optionally one or more parameters associated with the transmission mode. In some implementations, existing disregard and validate subfields 504 (associated with bits B20-B25 of U-SIG-1), a validate subfield 506 (associated with bit B2 of U-SIG-2), a validate subfield 508 (associated with bit B8 of U-SIG-2), and a UHR-SIG MCS subfield 510 (associated with bits B9-B10 of U-SIG-2), may be used to signal a transmission mode and/or one or more associated parameters. Further, in some implementations where a non-OFDMA UHR-SIG common field format is used, a spatial reuse subfield 522 (associated with bits B0-B3), a disregard subfield 524 (associated with bits B13-B15), and a number of non-OFDMA users subfield 526 (associated with bits B16-B18), may be used to signal a transmission mode and/or one or more associated parameters. In implementations where an OFDMA UHR-SIG common is used, a spatial reuse subfield 528 (associated with bits B0-B3) and a disregard subfield 530 (associated with bits B13-B16) may be used to signal a transmission mode and/or one or more associated parameters. FIGS. 6 through 8 illustrate some specific examples of how U-SIG, UHR-SIG common field, or both, may be used to convey advanced features signaling, such as information related to a transmission mode of a shared TXOP.

FIG. 6 shows an example of a U-SIG field of a PPDU 600 that supports signaling for transmission modes among access points. In this example, a U-SIG 602 field is illustrated, which may be transmitted by an AP to one or more STAs in accordance with transmission mode in which each AP may communicate with one or more STAs. The APs and STAs may be examples of the APs and STAs as described herein with respect to FIG. 1-5. The U-SIG 602 illustrates example signaling for indication of the COBF, C-SR, IM, and/or VS transmission modes. As shown in FIG. 6, the U-SIG 602 may include two portions, U-SIG-1 and U-SIG-2, in accordance with existing specifications.

As described herein, the wireless communication devices may implement a framework for selection and utilization of a transmission mode from a COBF transmission mode, a C-SR transmission mode, an IM transmission mode, and/or a VS transmission mode. The transmission modes may be used to determine when and how to share resources with other APs and when not to share such resources. In some implementations, a first subset of bits of the U-SIG 602 may provide a COBF or IM indication 606, where the first subset of bits include a single bit corresponding to bit B2 of U-SIG-2. In some implementations, a second subfield 604 of U-SIG 602 may provide a BSS color of the shared AP for the COBF transmission mode or one or more IM parameters for the IM transmission mode. In some implementations, such signaling may indicate COBF or IM (assumed for SU transmission only), and not C-SR or VS. In some implementations, the COBF or IM indication 606 in U-SIG-2 B2 may indicate COBF ON/OFF in non-OFDMA MU-MIMO or OFDMA, and IM ON/OFF in SU transmission. The basic transmission mode of non-OFDMA MU-MIMO, OFDMA or SU transmissions is indicated by the combination of the UL/DL subfield and the PPUD Type And Compression Mode field. In other implementations, the COBF indication or IM indication 606 in U-SIG-2 B2 may be a COBF indication to indicate COBF ON/OFF and may not depend on the basic transmission mode of non-OFDMA MU-MIMO or OFDMA transmission. In this case, if the COBF indication indicates COBF OFF (not in the COBF transmission mode), one bit within U-SIG-1 bits B20-B25 may be used to indicate IM ON/OFF. In some implementations, one or more IM parameters may be indicated in U-SIG-1 B20-B25 or elsewhere (such as by repurposing UHR-SIG MCS 608 of U-SIG 602, or the spatial reuse UHR-SIG common field bits B0-B3 (such as spatial reuse subfield 522 of UHR-SIG common field 520-a or spatial reuse subfield 528 of UHR-SIG common field 520-b) and/or number of non-OFDMA users subfield 526 of UHR-SIG common field 520-a). In some implementations, an indication of the VS mode may be provided using one bit to indicate VS ON/OFF, such as U-SIG-2 bit B8, one bit within U-SIG-1 bits B20-B25, or one bit within the disregard bits in UHR-SIG common field, such as UHR-SIG common field bits B13-B15 in non-OFDMA transmission and B13-B16 in OFDMA transmission. The one bit indication of the VS mode may be used if the PPDU is not in a multi-AP coordinated transmission mode such as the CoBF or CSR transmission mode, or it may be used to indicate the VS mode for the first AP.

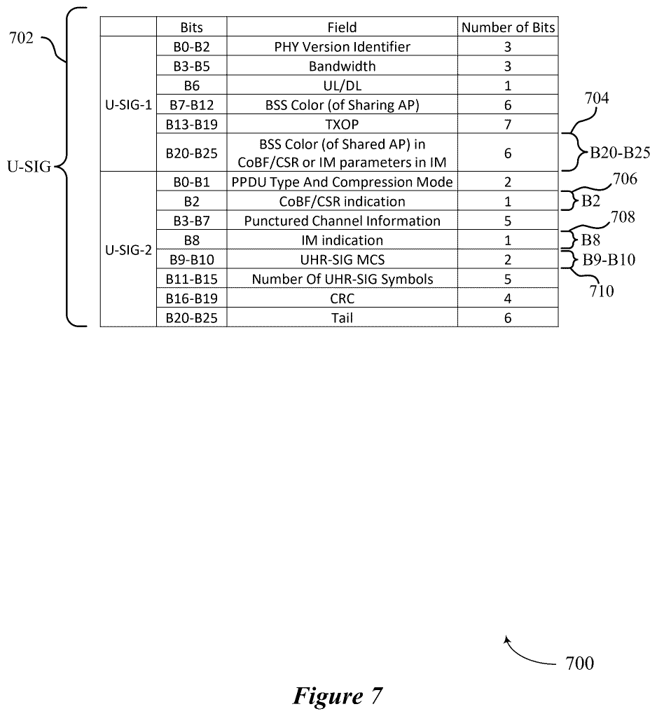

FIG. 7 shows an example of a U-SIG field of a PPDU 700 that supports signaling for transmission modes among access points. In this example, a U-SIG 702 field is illustrated, which may be transmitted by an AP to one or more STAs in accordance with a transmission mode in which each AP may communicate with one or more STAs. The APs and STAs may be examples of the APs and STAs as described herein with respect to FIG. 1-5. The U-SIG 702 illustrates example signaling for indication of the COBF, C-SR, IM, and/or VS transmission modes. As shown in FIG. 7, the U-SIG 702 may include two portions, U-SIG-1 and U-SIG-2, in accordance with existing specifications.

As described herein, the wireless communication devices may implement a framework for selection and utilization of a transmission mode from a COBF transmission mode, a C-SR transmission mode, an IM transmission mode, and/or a VS transmission mode. The transmission modes may be used to determine when and how to share resources with other APs and when not to share such resources. In some implementations, a first subset of bits of the U-SIG 702 may include COBF/C-SR indication 706 (corresponding to bit B2 of U-SIG-2) and IM indication 708 (corresponding to bit B8 of U-SIG-2), and thus the first subset of bits include non-adjacent bits within U-SIG 702. In some implementations, such signaling may indicate COBF, IM, and possibly C-SR (for SU), and may not indicate the VS transmission mode. In some implementations, U-SIG-2 bit B2 may be used to indicate C-SR ON/OFF in a SU transmission, and CoBF ON/OFF in a non-OFDMA MU-MIMO or OFDMA transmission. In some implementations, U-SIG-2 bit B8 or one bit within U-SIG-1 bits B20-B25 may be used to indicate IM ON/OFF, and a second subfield 704 of U-SIG 702 may provide a BSS color of the shared AP for the COBF or C-SR transmission mode, or one or more IM parameters for the IM transmission mode.

Additionally, or alternatively, IM parameters may be indicated elsewhere such as through repurposing UHR-SIG MCS 710 (corresponding to bits B9-B10 of U-SIG-2), or a spatial reuse or number of non-OFDMA users subfields of UHR-SIG common. In some implementations, an indication of the VS mode may be provided using one bit to indicate VS ON/OFF, such as U-SIG-2 bit B8 or one bit within U-SIG-1 bits B20-B25, or one bit within the disregard bits in UHR-SIG common field, such as UHR-SIG common field bits B13-B15 in non-OFDMA transmission and B13-B16 in OFDMA transmission.

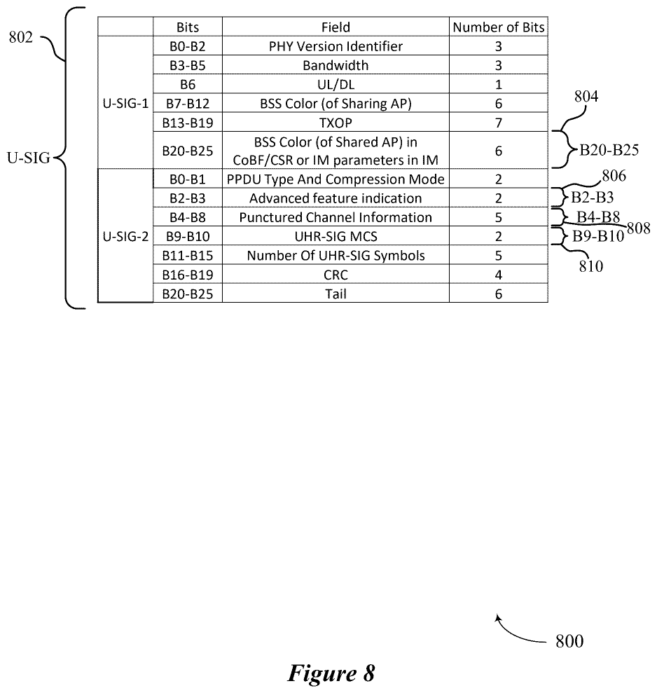

FIG. 8 shows an example of a U-SIG field of a PPDU 800 that supports signaling for transmission modes among access points. In this example, a U-SIG 802 field is illustrated, which may be transmitted by an AP to one or more STAs in accordance with a transmission mode in which each AP may communicate with one or more STAs. The APs and STAs may be examples of the APs and STAs as described herein with respect to FIG. 1-5. The U-SIG 802 illustrates example signaling for indication of the COBF, C-SR, IM, and/or VS transmission modes. As shown in FIG. 8, the U-SIG 802 may include two portions, U-SIG-1 and U-SIG-2, in accordance with existing specifications.

As described herein, the wireless communication devices may implement a framework for selection and utilization of a transmission mode from a COBF transmission mode, a C-SR transmission mode, an IM transmission mode, and/or a VS transmission mode. The transmission modes may be used to determine when and how to share resources with other APs and when not to share such resources. In some implementations, a first subset of bits of the U-SIG 802 may include advanced feature indication 806 (corresponding to adjacent bits B2-B3 of U-SIG-2). In this example, U-SIG 802 has a different format than formats of prior specifications, and punctured channel information 808 may be mode to occupy bits B4-B8 of U-SIG-2. In some implementations, such signaling may indicate advanced features are off, that COBF is on, that C-SR is on, or that IM is on. In some implementations, the first subset of bits may indicate CoBF ON/OFF (and may reduced to B2) in the case of non-OFDMA MU-MIMO or OFDMA, and indicate OFF, C-SR ON, or IM ON in the case of a SU transmission. In some implementations, a second subfield 804 of U-SIG 802 may provide a BSS color of the shared AP for the COBF or C-SR transmission mode, or one or more IM parameters for the IM transmission mode. Additionally, or alternatively, IM parameters may be indicated elsewhere such as through repurposing UHR-SIG MCS 810 (corresponding to bits B9-B10 of U-SIG-2), or a spatial reuse or number of non-OFDMA users subfields of UHR-SIG common. In some implementations, an indication of the VS transmission mode may be provided using one bit to indicate VS ON/OFF, such as U-SIG-2 bit B8 or one bit within U-SIG-1 bits B20-B25, or one bit within the disregard bits in UHR-SIG common field, such as UHR-SIG common field bits B13-B15 in non-OFDMA transmission and B13-B16 in OFDMA transmission.

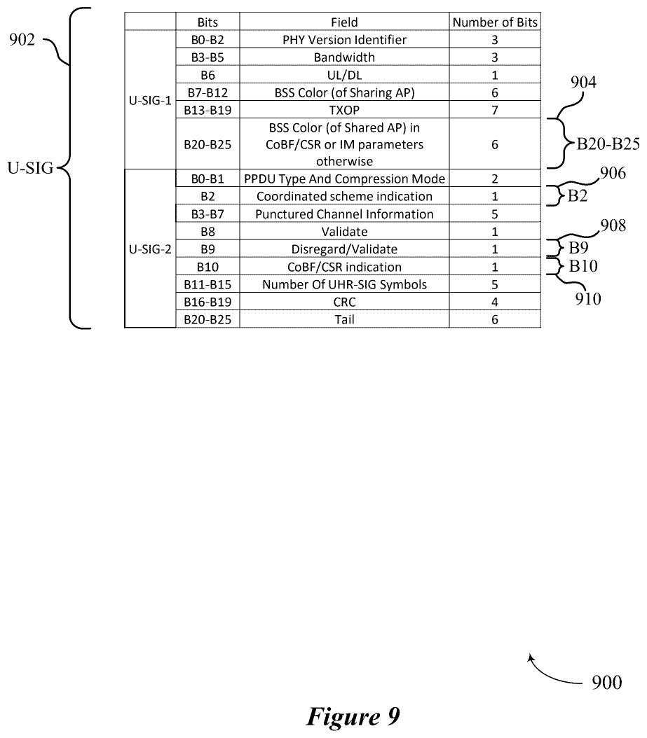

FIG. 9 shows an example of a U-SIG field of a PPDU 900 that supports signaling for transmission modes among access points. In this example, a U-SIG 902 field is illustrated, which may be transmitted by an AP to one or more STAs in accordance with a transmission mode in which each AP may communicate with one or more STAs. The APs and STAs may be examples of the APs and STAs as described herein with respect to FIG. 1-5. The U-SIG 902 illustrates example signaling for indication of the COBF, C-SR, IM, and/or VS transmission modes. As shown in FIG. 9, the U-SIG 902 may include two portions, U-SIG-1 and U-SIG-2, in accordance with existing specifications.

As described herein, the wireless communication devices may implement a framework for selection and utilization of a transmission mode from a COBF transmission mode, a C-SR transmission mode, an IM transmission mode, and/or a VS transmission mode. The transmission modes may be used to determine when and how to share resources with other APs and when not to share such resources. In some implementations, a first subset of bits of the U-SIG 902 may include a coordinated scheme indication 906 (corresponding to bit B2 of U-SIG-2). In some implementations, such signaling may indicate a coordinated scheme, such as COBF or C-SR, is on or off. In some implementations, the first subset of bits may also include bit B9 908 or bit B10 910 of the U-SIG-2 field, which may indicate whether COBF or C-SR is enabled (such as by assuming the UHR-SIG is transmitted using a fixed MCS such as MCS0 and repurposing the 2-bit UHR-SIG MCS field of bits B9 908 and B10 910), when the coordinated scheme indication 906 indicates that a coordinated scheme is enabled. An unused bit within bits B9 908 and B10 910 may be set as a reserved bit, a disregard bit or a validate bit.

In some implementations, a second subfield 904 of U-SIG 902 may provide a BSS color of the shared AP for the COBF or C-SR transmission mode, or an IM indication and one or more IM parameters for the IM transmission mode when the coordinated scheme indication 906 indicates that a coordinated scheme is disabled. In some implementations, the VS transmission mode may be indicated with a bit within the second subfield 904 (in cases where VS is mutually exclusive from COBF and C-SR) or may be indicated by one or more bits in the UHR-SIG common field, or one bit within the disregard bits in UHR-SIG common field, such as UHR-SIG common field bits B13-B15 in non-OFDMA transmission and B13-B16 in OFDMA transmission.

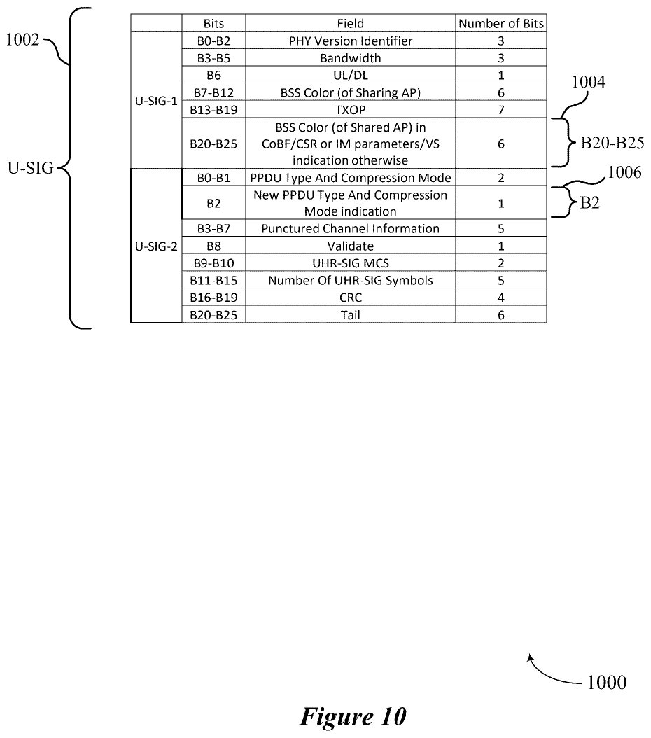

FIG. 10 shows an example of a U-SIG field of a PPDU 1000 that supports signaling for transmission modes among access points. In this example, a U-SIG 1002 field is illustrated, which may be transmitted by an AP to one or more STAs in accordance with a transmission mode in which each AP may communicate with one or more STAs. The APs and STAs may be examples of the APs and STAs as described herein with respect to FIG. 1-5. The U-SIG 1002 illustrates example signaling for indication of the COBF, C-SR, IM, and/or VS transmission modes. As shown in FIG. 10, the U-SIG 1002 may include two portions, U-SIG-1 and U-SIG-2, in accordance with existing specifications.

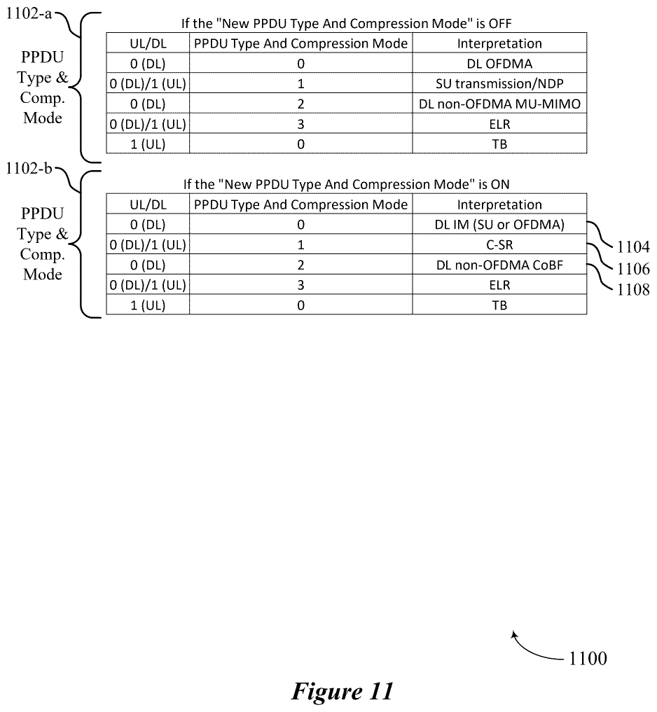

In the example of FIG. 10, a first subset of bits of the U-SIG 1002 may include a new PPDU Type And Compression Mode indication 1006 (corresponding to bit B2 of U-SIG-2). In this example, if the new PPDU Type And Compression Mode indication 1006 has a first value (such as a ‘1’ that indicates ON), then, in accordance with the indication in the UL/DL subfield, the PPDU Type and Compression Mode subfield is interpreted differently than a legacy PPDU Type and Compression Mode subfield. In some implementations, bit values of the PPDU Type and Compression Mode subfield may be interpreted to indicate uplink/downlink enhanced long range (ELR), TB PPDUs, downlink non-OFDMA COBF, downlink SU C-SR, and/or downlink IM (SU or OFDMA) transmission modes. An example of the PPDU Type and Compression Mode subfield is discussed in more detail with reference to FIG. 11. In some implementations, a second subfield 1004 of U-SIG 1002 may provide a BSS color of the second AP for the COBF or C-SR transmission mode, one or more IM parameters for the IM transmission mode, or a VS indication and/parameters if COBF, C-SR and IM are not enabled. In some implementations, an IM indication and one or more associated parameters may be provided in the second subfield 1004, and an indication of the IM transmission may not be provided by the new PPDU Type and compression mode subfield. In some implementations, IM may be combined with different transmission modes, such as SU, OFDMA, and the like. In some implementations, the VS transmission mode may be indicated by a bit within the second subfield 1004, when the VS transmission mode is mutually exclusive from COBF and C-SR, or an indication of the VS transmission mode may be provided in the UHR-SIG common field.

FIG. 11 shows examples of a PPDU Type And Compression Mode subfield 1100, that support signaling for transmission modes among access points. In this example, a first interpretation 1102-a of the PPDU Type And Compression Mode subfield 1100 may be used when the new PPDU Type And Compression Mode indication 1006 has a second value (such as ‘0’) and may provide a legacy interpretation, in which combinations of uplink/downlink indications and PPDU Type And Compression Mode indications are interpreted to indicate a DL OFDMA, SU transmission/NDP, downlink non-OFDMA MU-MIMO, ELR, or TB transmission mode. In some implementations, a second interpretation 1102-b of the PPDU Type And Compression Mode subfield 1100 may be used when the new PPDU Type And Compression Mode indication 1006 has a first value (such as ‘1’), in accordance with the indication in the UL/DL subfield, and may provide a first indication 1104 of downlink IM for SU or OFDMA transmissions for a downlink indication with PPDU Type And Compression Mode 0; may provide a second indication 1106 of C-SR for a downlink or uplink indication with PPDU Type And Compression Mode 1; may provide a third indication 1108 of downlink non-OFDMA COBF for a downlink indication with PPDU Type And Compression Mode 2; and may provide an ELR or TB indication in accordance with the first interpretation 1102-a. In some other examples, the first indication 1104 may be reserved and not indicate IM, and the IM transmission mode may be indicated elsewhere such as in various examples discussed herein.

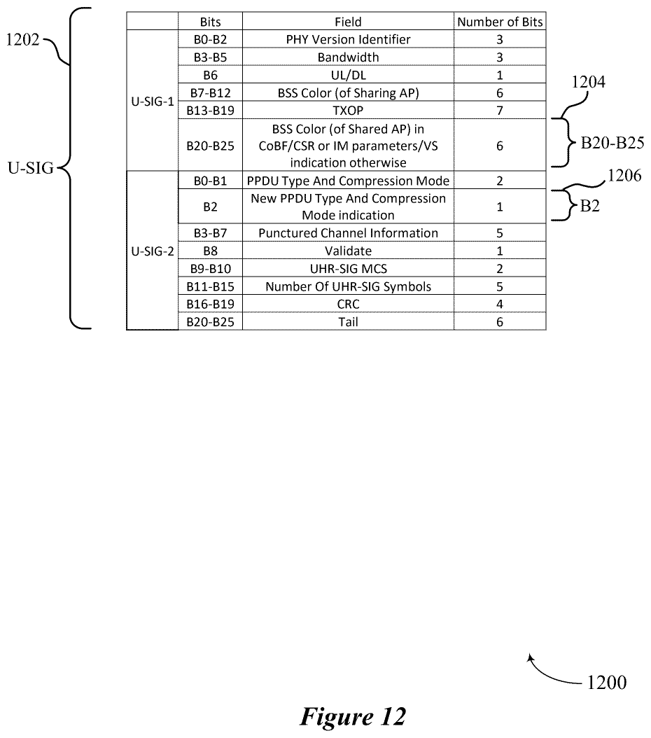

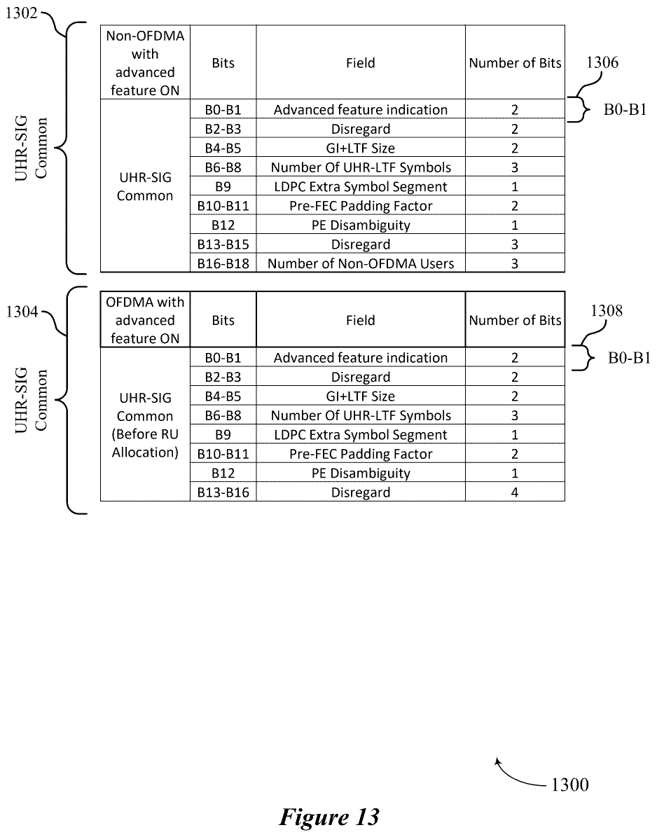

FIG. 12 shows an example of a U-SIG field of a PPDU 1200 that supports signaling for transmission modes among one or more access points, and FIG. 13 shows examples of a common field of a UHR-SIG 1300. In this example, a U-SIG 1202 field is illustrated, which may be transmitted by one or two APs to one or more STAs in accordance with a transmission mode in which each AP may communicate with one or more STAs. The APs and STAs may be examples of the APs and STAs as described herein with respect to FIG. 1-5. The U-SIG 1202 illustrates example signaling for indication of the COBF, C-SR, IM, and/or VS transmission modes. As shown in FIG. 12, the U-SIG 1202 may include two portions, U-SIG-1 and U-SIG-2, in accordance with existing specifications.

In the example of FIG. 12, a first subset of bits of the U-SIG 1202 may include a new PPDU Type And Compression Mode indication 1206 (corresponding to bit B2 of U-SIG-2). In this example, if the new PPDU Type And Compression Mode indication 1206 has a first value (such as a ‘1’ that indicates ON), then, in accordance with the indication in the UL/DL subfield, the PPDU Type and Compression Mode subfield is interpreted differently than a legacy PPDU Type and Compression Mode subfield. In some implementations, as illustrated in FIG. 13, a 4-bit spatial reuse field of UHR-SIG may be repurposed to a 2-bit disregard and 2-bit advanced feature, such as 2-bit advanced feature indication field 1306 of UHR-SIG common 1302 or 2-bit advanced feature indication field 1308 of UHR-SIG common 1304, to indicate the specific CoBF/CSR/IM, leaving one validate state. In some implementations, U-SIG-1 B20-B25 may be a set of bits 1204 that indicate the second BSS Color in CoBF/C-SR, and these 6 bits are all disregard bits if no advanced feature is ON. In some implementations, IM parameters (if any) in the case of IM ON, may be in the set of bits 1204 of U-SIG-1 B20-B25 or elsewhere (such as other disregard/validate bits, repurposing UHR-SIG MCS, two disregard bits from repurposing spatial reuse, or repurposing number of non-OFDMA users subfield).

In some implementations, it may be assumed that no VS is present in the case of CoBF or C-SR. In some implementations, VS ON may be indicated in a bit within U-SIG-1 B20-B25 (if mutually exclusive from CoBF and C-SR) or in UHR-SIG common field (e.g., using 1 disregard bit from B13-B15 in UHR-SIG common field) In other implementations, CoBF, IM, C-SR and VS may be indicated, and one bit may be used if there is no CoBF or CSR, or two bits in the case of CoBF or C-SR to indicate per BSS (or per AP) VS. For example, VS ON may be indicated in the UHR-SIG common field (e.g., using 1 or 2 disregard bits from B13-B15 in UHR-SIG common field). In some implementations, with reference to FIG. 13, the UHR-SIG common field formats in basic non-OFDMA 1302 and OFDMA 1304 may switch the GI+LTF size subfield (B4-B5) with two disregard bits (B13-B14).

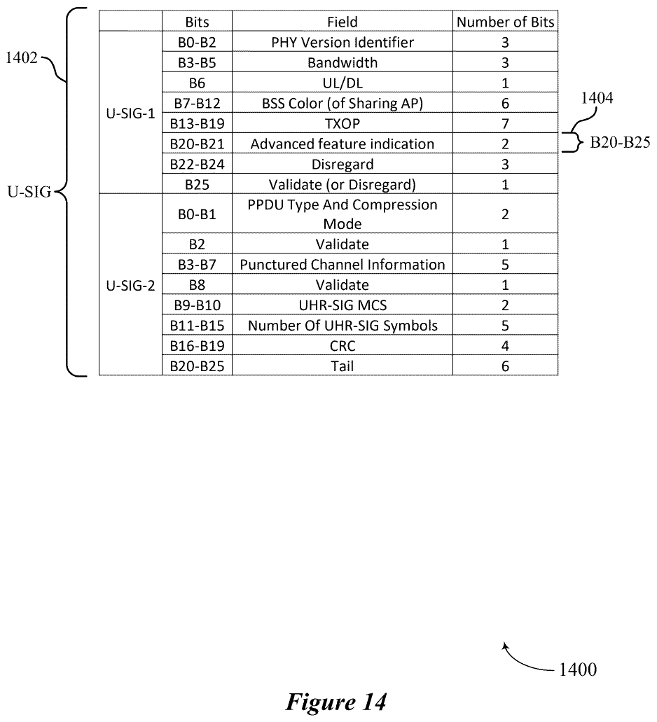

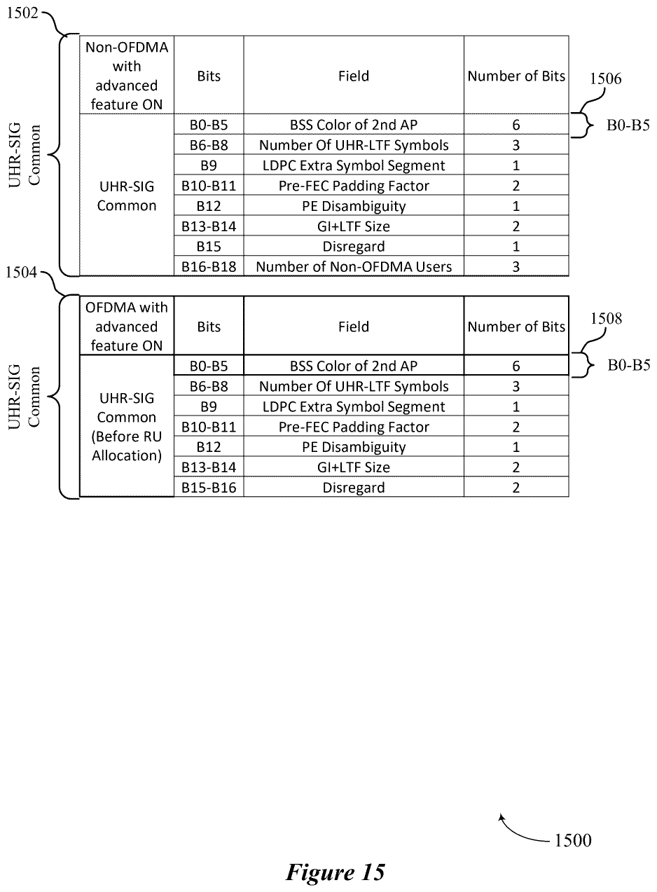

FIG. 14 shows an example of a U-SIG field of a PPDU 1400, and FIG. 15 shows examples of a common field of a UHR-SIG 1500, that support signaling for transmission modes among access points. In this example, a U-SIG 1402 field is illustrated, which may be transmitted by an AP to one or more STAs in accordance with a transmission mode in which each AP may communicate with one or more STAs. The APs and STAs may be examples of the APs and STAs as described herein with respect to FIG. 1-5. The U-SIG 1402 illustrates example signaling for indication of the COBF, C-SR, IM, and/or VS transmission modes. As shown in FIG. 14, the U-SIG 1402 may include two portions, U-SIG-1 and U-SIG-2, in accordance with existing specifications.

In the example of FIG. 14, a first subset of bits of the U-SIG 1402 may include an advanced feature indication 1404 (corresponding to bits B20-B21 of U-SIG-1). In this example, the two bits within U-SIG-1 B20-B25 may indicate advanced features of {OFF, CoBF ON, CSR ON, IM ON}. In some implementations, U-SIG-2 B0-B5 may be used to indicate the 2nd BSS Color in CoBF/C-SR, where these 6 bits are from repurposing 4-bit spatial reuse and 2 disregard bits if no advanced feature is ON. In some implementations, the spatial reuse field may be kept if IM is ON In some implementations, CoBF, IM, and C-SR may be indicated, and IM parameters (if any) in the case of IM ON, may be in disregard bits in U-SIG-1 (e.g., B20-B24 or B25 if it is a disregard bit) or elsewhere (e.g., other disregard bits in UHR-SIG, repurposing UHR-SIG MCS, repurposing spatial reuse, repurposing number of non-OFDMA users subfield). In some implementations CoBF, IM, C-SR and VS may be indicated. In some implementations, no VS may be assumed in the case of CoBF or C-SR, and VS ON may be indicated in a bit within U-SIG-1 (i.e., B20-B24 or B25 if it is a disregard bit) or U-SIG-2 (such as using a validate bit) or the common field in UHR-SIG such as using a disregard bit (e.g., using 1 disregard bit from B4-B5 and B15 in UHR-SIG common field). In some implementations, CoBF, IM, C-SR and VS may be indicated, and one bit may be assumed if there is no CoBF or CSR, or two bits in the case of CoBF or C-SR to indicate per BSS (or per AP) VS. In some implementations a VS ON indication may use 1 or 2 bits in U-SIG (e.g., using 1 or 2 bits in U-SIG-1 B20-B24 or B25 if it is a disregard bit) or UHR-SIG common field (e.g., using 1 disregard bit B15 in UHR-SIG common field).

In some implementations, locations for the 6-bit BSS color of the 2nd AP may be at U-SIG-1 B20-B25, UHR-SIG B0-B5 1506 such in UHR-SIG common 1502, or UHR-SIG B0-B5 1508 in UHR-SIG common 1504. The location may be independent from how and where CoBF or CSR is indicated, and the location may depend on how and where CoBF or CSR is indicated.

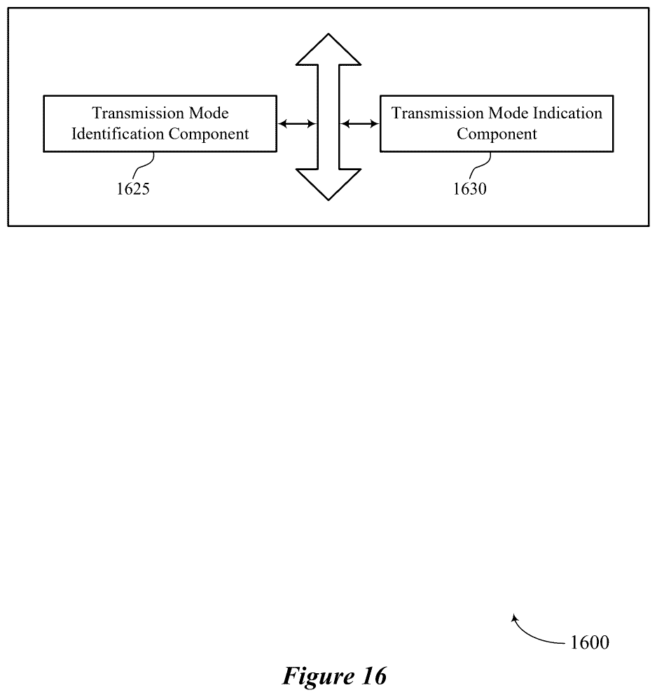

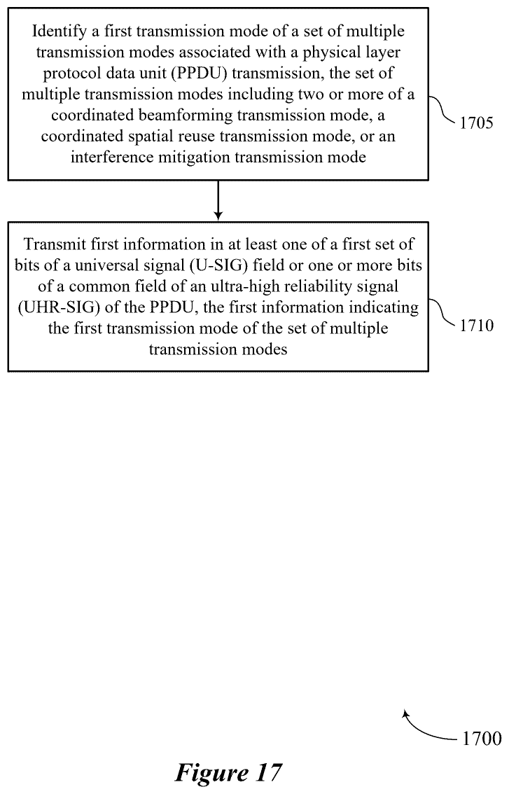

FIG. 16 shows a block diagram of an example wireless communication device 1600 that supports signaling for transmission modes among access points. In some examples, the wireless communication device 1600 is configured to perform the processes 1700, 1800, 1900, 2000, 2100, 2200, 2300, and 2400 described with reference to FIGS. 17, 18, 19, 20, 21, 22, 23, and 24, respectively. The wireless communication device 1600 may include one or more chips, SoCs, chipsets, packages, components or devices that individually or collectively constitute or include a processing system. The processing system may interface with other components of the wireless communication device 1600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1600 may transmit the information output from the chip. In such an example, the second interface may refer to an interface between the processing system of the chip and a reception component, such that the wireless communication device 1600 may receive information that is then passed to the processing system. In some such examples, the first interface also may obtain information, such as from the transmission component, and the second interface also may output information, such as to the reception component.

The processing system of the wireless communication device 1600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1600 can be configurable or configured for use in an AP, such as the AP 102 described with reference to FIG. 1. In some other examples, the wireless communication device 1600 can be an AP that includes such a processing system and other components including multiple antennas. The wireless communication device 1600 is capable of transmitting and receiving wireless communications in the form of, for example, wireless packets. For example, the wireless communication device 1600 can be configurable or configured to transmit and receive packets in the form of physical layer PPDUs and MPDUs conforming to one or more of the IEEE 802.11 family of wireless communication protocol standards. In some other examples, the wireless communication device 1600 can be configurable or configured to transmit and receive signals and communications conforming to one or more 3GPP specifications including those for 5G NR or 6G. In some examples, the wireless communication device 1600 also includes or can be coupled with one or more application processors which may be further coupled with one or more other memories. In some examples, the wireless communication device 1600 further includes at least one external network interface coupled with the processing system that enables communication with a core network or backhaul network that enables the wireless communication device 1600 to gain access to external networks including the Internet.

The wireless communication device 1600 includes a transmission mode identification component 1625 and a transmission mode indication component 1630. Portions of one or more of the transmission mode identification component 1625 and the transmission mode indication component 1630 may be implemented at least in part in hardware or firmware. For example, one or more of the transmission mode identification component 1625 and the transmission mode indication component 1630 may be implemented at least in part by at least a processor or a modem. In some examples, portions of one or more of the transmission mode identification component 1625 and the transmission mode indication component 1630 may be implemented at least in part by a processor and software in the form of processor-executable code stored in memory.

The wireless communication device 1600 may support wireless communications in accordance with examples as disclosed herein. The transmission mode identification component 1625 is configurable or configured to identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, or an interference mitigation transmission mode. The transmission mode indication component 1630 is configurable or configured to transmit first information in at least one of a first set of bits of a universal signal (U-SIG) field or one or more bits of a common field of an ultra-high reliability signal (UHR-SIG) of the PPDU, the first information indicating the first transmission mode of the set of multiple transmission modes.

In some examples, the first set of bits of the U-SIG field includes a one bit subfield that indicates whether the first transmission mode is the coordinated beamforming transmission mode in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or the first set of bits indicates whether the first transmission mode is the interference mitigation transmission mode in accordance with the PPDU Type And Compression Mode field that indicates a transmission to a single user, and where a second set of bits of the U-SIG field indicates either a first basic service set color of the first access point or a second basic service set color of a second access point for the coordinated beamforming transmission mode, or one or more interference mitigation parameters for the interference mitigation transmission mode, or reserved bits defined as disregard bits or validate bits.

In some examples, the first set of bits of the U-SIG field includes a first bit, and different combinations of bit values of the first bit and a second bit in the U-SIG field or in the common field of the UHR-SIG indicates the first transmission mode is the coordinated beamforming transmission mode, the coordinated spatial reuse transmission mode, or the interference mitigation transmission mode, and a second set of bits of the U-SIG field, or one or more bits of the common field of the UHR-SIG, indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

In some examples, the first set of bits of the U-SIG field, or two bits of the common field of the UHR-SIG, includes a two bit subfield that indicates the first transmission mode is the coordinated beamforming transmission mode, the coordinated spatial reuse transmission mode, or the interference mitigation transmission mode, and where a second set of bits of the U-SIG field or the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples, the first set of bits of the U-SIG field includes a first bit that indicates whether one of the set of multiple transmission modes is enabled, and a second set of bits in the common field of the UHR-SIG indicates the first transmission mode is the coordinated beamforming transmission mode, the coordinated spatial reuse transmission mode, or the interference mitigation transmission mode, and a third set of bits of the U-SIG field or the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples, the first set of bits of the U-SIG field includes a two bit subfield that indicates the first transmission mode is the coordinated beamforming transmission mode, the coordinated spatial reuse transmission mode, or the interference mitigation transmission mode, and a second set of bits of the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples, the first set of bits of the U-SIG field includes first bit that indicates whether a coordinated transmission scheme is used and second bit that indicates whether coordinated beamforming or coordinated spatial reuse is used when the first bit indicates the coordinated transmission scheme, and a second set of bits of the U-SIG field indicates either a first basic service set color of the first access point or a second basic service set color of a second access point for the coordinated beamforming or coordinated spatial reuse transmission mode, or an interference mitigation indication and one or more interference mitigation parameters for the interference mitigation transmission mode if the first bit does not indicate the coordinated transmission scheme, or the second set of bits of the U-SIG field are reserved bits defined as disregard bits or validate bits.

In some examples, the first set of bits of the U-SIG field includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user transmission mode with coordinated spatial reuse, or a single user transmission mode with interference mitigation, and a second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

In some examples, the transmission mode indication component 1630 is configurable or configured to transmit, in accordance with the first transmission mode being a vendor specific transmission mode, at least one of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within the common field of an ultra-high reliability signal (UHR-SIG) field, or a vendor specific information using one or more bits of subfields within a user field of the UHR-SIG field.

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the first transmission mode including a coordinated beamforming transmission mode or an interference mitigation transmission mode. In some examples, the transmission mode indication component 1630 is configurable or configured to transmit a transmission mode indicator in the PPDU, the transmission mode indicator including a first set of bits of a universal signal (U-SIG) field of the PPDU, and transmission mode information in a second set of bits of the U-SIG field, where the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode.

In some examples, at least one of a single bit to indicate interference mitigation is enabled or disabled, or the one or more interference mitigation parameters, are indicated in a first portion of the U-SIG field (U-SIG-1) using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

In some examples, a vendor specific transmission mode is indicated using a one bit indicator in the U-SIG field or a common field of an ultra-high reliability signal (UHR-SIG) that is different from the transmission mode indicator.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, an interference mitigation transmission mode, or a vendor specific transmission mode. In some examples, the transmission mode indication component 1630 is configurable or configured to transmit a transmission mode indicator in the PPDU, the transmission mode indicator including a first bit and a second bit of a universal signal (U-SIG) field and transmission mode information in a subfield of the U-SIG field, where the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode.

In some examples, the first bit of the U-SIG field indicates whether the coordinated beamforming transmission mode is enabled or disabled for non-orthogonal frequency division multiple access (non-OFDMA) multi-user (MU) multiple-input multiple-output (MIMO) communications or OFDMA communications, or whether the coordinated spatial reuse transmission mode is enabled or disabled for single-user (SU) communications.

In some examples, at least one of the second bit of the U-SIG field, or one bit within a first portion of the U-SIG field (U-SIG-1) indicates whether the interference mitigation transmission mode is enabled or disabled, and when the interference mitigation transmission mode is enabled, the one or more interference mitigation parameters are indicated in the U-SIG-1 using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

In some examples, the vendor specific transmission mode is indicated using a one bit indicator in the U-SIG field or a common field of an ultra-high reliability signal (UHR-SIG) that is different from the transmission mode indicator.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, vendor specific information using one or more bits within a common field of an ultra-high reliability signal (UHR-SIG), or a vendor specific information using one or more bits of subfields within a user field of an ultra-high reliability signal (UHR-SIG).

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. In some examples, the transmission mode indication component 1630 is configurable or configured to transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples, a first bit value of the first set of bits indicates that one or more advanced features for communications are disabled, a second bit value of the first set of bits indicates that the coordinated beamforming transmission mode is enabled, a third bit value of the first set of bits indicates that the coordinated spatial reuse transmission mode is enabled, and a fourth bit value of the first set of bits indicates that the interference mitigation transmission mode is enabled.

In some examples, the one or more interference mitigation parameters are indicated in a first portion of the U-SIG field (U-SIG-1) using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

In some examples, a vendor specific transmission mode is indicated using a one bit indicator in the U-SIG field, or a common field of an ultra-high reliability signal (UHR-SIG), that is different from the transmission mode indicator.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within an ultra-high reliability signal (UHR-SIG) common field, or a vendor specific information using one or more bits of subfields within a user field of the UHR-SIG field.

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. In some examples, the transmission mode indication component 1630 is configurable or configured to transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits.

In some examples, the one or more interference mitigation parameters are indicated in a first portion of the U-SIG field (U-SIG-1).

In some examples, a vendor specific transmission mode is indicated using a one bit indicator in the U-SIG field, or the common field of the UHR-SIG, that is different from the first set of bits.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within an ultra-high reliability signal (UHR-SIG) common field, or a vendor specific information using one or more bits of subfields within a user field of the UHR-SIG field.

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. In some examples, the transmission mode indication component 1630 is configurable or configured to transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

In some examples, a vendor specific transmission mode is indicated using a one bit indicator in the U-SIG field or a common field of an ultra-high reliability signal (UHR-SIG) that is different from the transmission mode indicator.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. In some examples, the transmission mode indication component 1630 is configurable or configured to transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, where the first set of bits includes a first bit that indicates whether one of the set of multiple transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

In some examples, a vendor specific transmission mode is indicated using a one bit indicator in the U-SIG field or a common field of an ultra-high reliability signal (UHR-SIG) that is different from the transmission mode indicator.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Additionally, or alternatively, the wireless communication device 1600 may support wireless communications in accordance with examples as disclosed herein. In some examples, the transmission mode identification component 1625 is configurable or configured to identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. In some examples, the transmission mode indication component 1630 is configurable or configured to transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, where the first set of bits includes a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits.

In some examples, a vendor specific transmission mode is indicated using a one bit indicator in the U-SIG field or a common field of an ultra-high reliability signal (UHR-SIG) that is different from the transmission mode indicator.

In some examples, the transmission mode indication component 1630 is configurable or configured to transmit, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

FIG. 17 shows a flowchart illustrating an example process 1700 performable by or at a first access point that supports signaling for transmission modes among access points. The operations of the process 1700 may be implemented by a first access point or its components as described herein. For example, the process 1700 may be performed by a wireless communication device, such as the wireless communication device 1600 described with reference to FIG. 16, operating as or within a wireless AP. In some examples, the process 1700 may be performed by a wireless AP, such as one of the APs 102 described with reference to FIG. 1.

In some examples, in 1705, the first access point may identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, or an interference mitigation transmission mode. The operations of 1705 may be performed in accordance with examples as disclosed herein. In some implementations, aspects of the operations of 1705 may be performed by a transmission mode identification component 1625 as described with reference to FIG. 16.

In some examples, in 1710, the first access point may transmit first information in at least one of a first set of bits of a universal signal (U-SIG) field or one or more bits of a common field of an ultra-high reliability signal (UHR-SIG) of the PPDU, the first information indicating the first transmission mode of the set of multiple transmission modes. The operations of 1710 may be performed in accordance with examples as disclosed herein. In some implementations, aspects of the operations of 1710 may be performed by a transmission mode indication component 1630 as described with reference to FIG. 16.

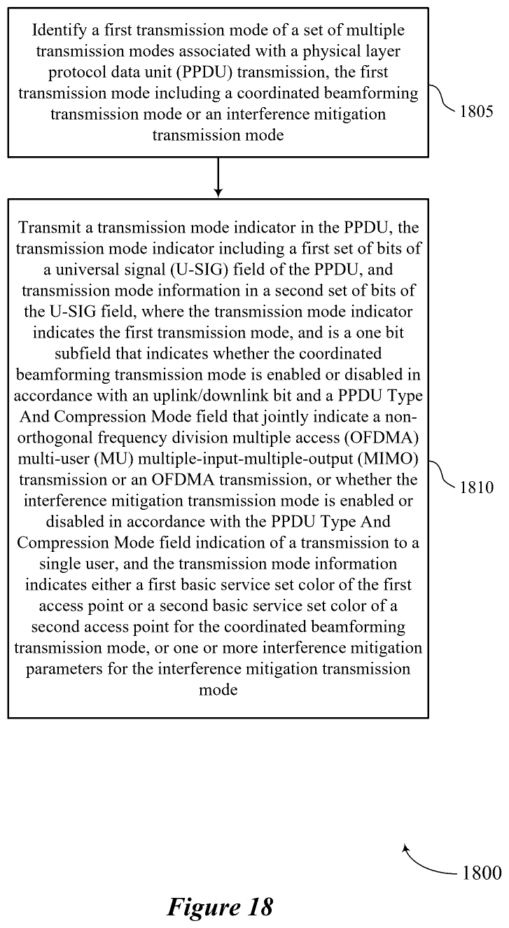

FIG. 18 shows a flowchart illustrating an example process 1800 performable by or at a first access point that supports signaling for transmission modes among access points. The operations of the process 1800 may be implemented by a first access point or its components as described herein. For example, the process 1800 may be performed by a wireless communication device, such as the wireless communication device 1600 described with reference to FIG. 16, operating as or within a wireless AP. In some examples, the process 1800 may be performed by a wireless AP, such as one of the APs 102 described with reference to FIG. 1.

In some examples, in 1805, the first access point may identify a first transmission mode of a set of multiple transmission modes associated with a physical layer protocol data unit (PPDU) transmission, the first transmission mode including a coordinated beamforming transmission mode or an interference mitigation transmission mode. The operations of 1805 may be performed in accordance with examples as disclosed herein. In some implementations, aspects of the operations of 1805 may be performed by a transmission mode identification component 1625 as described with reference to FIG. 16.

In some examples, in 1810, the first access point may transmit a transmission mode indicator in the PPDU, the transmission mode indicator including a first set of bits of a universal signal (U-SIG) field of the PPDU, and transmission mode information in a second set of bits of the U-SIG field, where the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode. The operations of 1810 may be performed in accordance with examples as disclosed herein. In some implementations, aspects of the operations of 1810 may be performed by a transmission mode indication component 1630 as described with reference to FIG. 16.

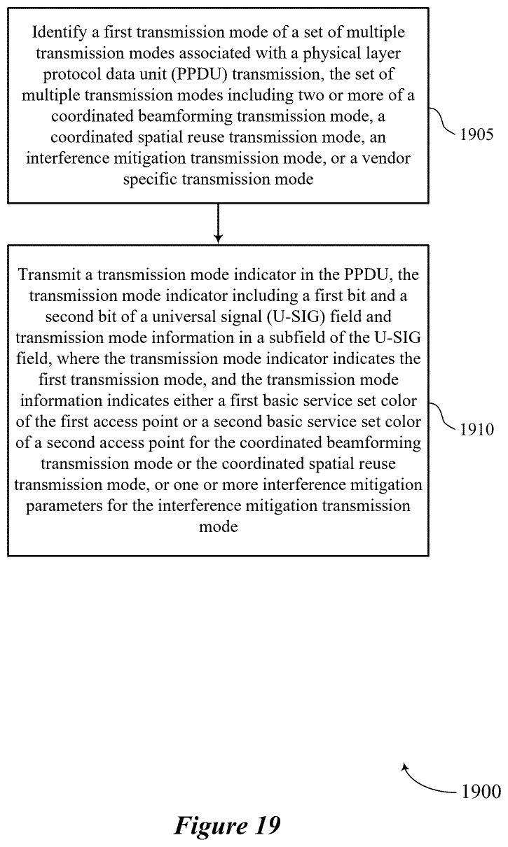

FIG. 19 shows a flowchart illustrating an example process 1900 performable by or at a first access point that supports signaling for transmission modes among access points. The operations of the process 1900 may be implemented by a first access point or its components as described herein. For example, the process 1900 may be performed by a wireless communication device, such as the wireless communication device 1600 described with reference to FIG. 16, operating as or within a wireless AP. In some examples, the process 1900 may be performed by a wireless AP, such as one of the APs 102 described with reference to FIG. 1.

In some examples, in 1905, the first access point may identify a first transmission mode of a set of multiple transmission modes associated with a physical layer protocol data unit (PPDU) transmission, the set of multiple transmission modes including two or more of a coordinated beamforming transmission mode, a coordinated spatial reuse transmission mode, an interference mitigation transmission mode, or a vendor specific transmission mode. The operations of 1905 may be performed in accordance with examples as disclosed herein. In some implementations, aspects of the operations of 1905 may be performed by a transmission mode identification component 1625 as described with reference to FIG. 16.

In some examples, in 1910, the first access point may transmit a transmission mode indicator in the PPDU, the transmission mode indicator including a first bit and a second bit of a universal signal (U-SIG) field and transmission mode information in a subfield of the U-SIG field, where the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode. The operations of 1910 may be performed in accordance with examples as disclosed herein. In some implementations, aspects of the operations of 1910 may be performed by a transmission mode indication component 1630 as described with reference to FIG. 16.

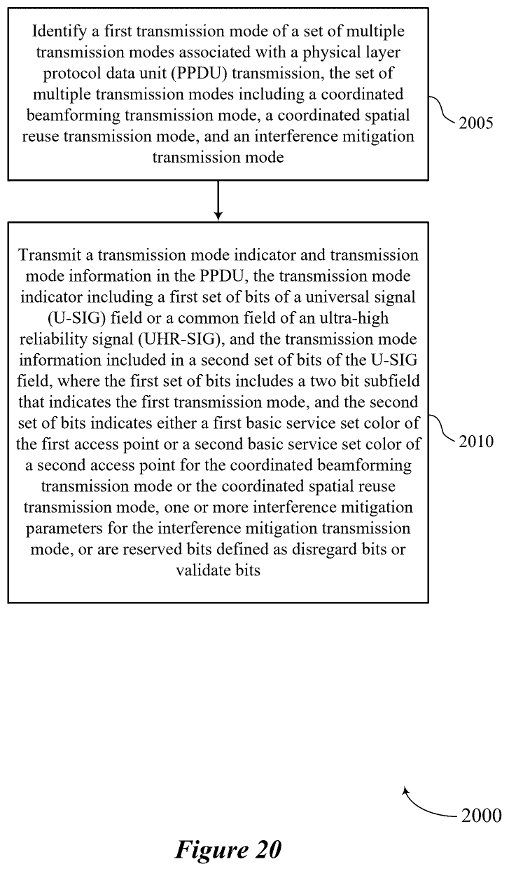

FIG. 20 shows a flowchart illustrating an example process 2000 performable by or at a first access point that supports signaling for transmission modes among access points. The operations of the process 2000 may be implemented by a first access point or its components as described herein. For example, the process 2000 may be performed by a wireless communication device, such as the wireless communication device 1600 described with reference to FIG. 16, operating as or within a wireless AP. In some examples, the process 2000 may be performed by a wireless AP, such as one of the APs 102 described with reference to FIG. 1.

In some examples, in 2005, the first access point may identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. The operations of 2005 may be performed in accordance with examples as disclosed herein. In some implementations, aspects of the operations of 2005 may be performed by a transmission mode identification component 1625 as described with reference to FIG. 16.

In some examples, in 2010, the first access point may transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits. The operations of 2010 may be performed in accordance with examples as disclosed herein. In some implementations, aspects of the operations of 2010 may be performed by a transmission mode indication component 1630 as described with reference to FIG. 16.

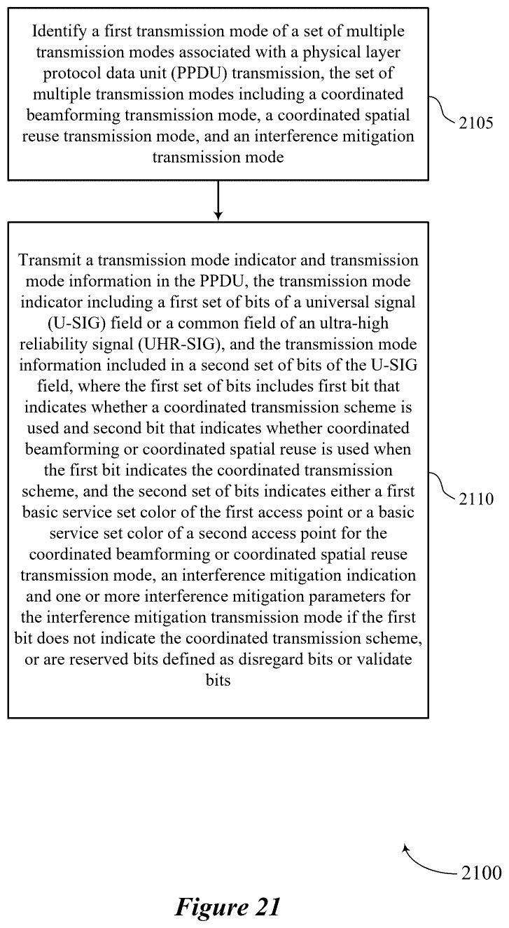

FIG. 21 shows a flowchart illustrating an example process 2100 performable by or at a first access point that supports signaling for transmission modes among access points. The operations of the process 2100 may be implemented by a first access point or its components as described herein. For example, the process 2100 may be performed by a wireless communication device, such as the wireless communication device 1600 described with reference to FIG. 16, operating as or within a wireless AP. In some examples, the process 2100 may be performed by a wireless AP, such as one of the APs 102 described with reference to FIG. 1.

In some examples, in 2105, the first access point may identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. The operations of 2105 may be performed in accordance with examples as disclosed herein. In some implementations, aspects of the operations of 2105 may be performed by a transmission mode identification component 1625 as described with reference to FIG. 16.

In some examples, in 2110, the first access point may transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits. The operations of 2110 may be performed in accordance with examples as disclosed herein. In some implementations, aspects of the operations of 2110 may be performed by a transmission mode indication component 1630 as described with reference to FIG. 16.

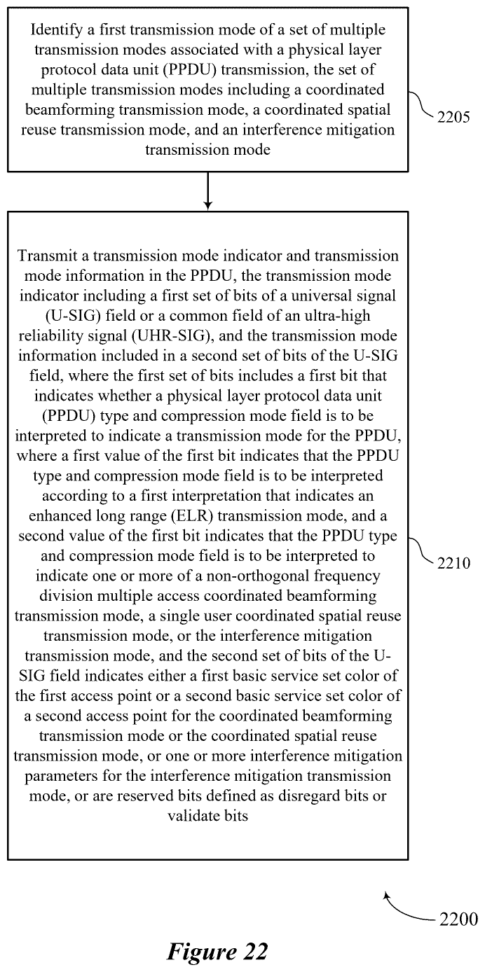

FIG. 22 shows a flowchart illustrating an example process 2200 performable by or at a first access point that supports signaling for transmission modes among access points. The operations of the process 2200 may be implemented by a first access point or its components as described herein. For example, the process 2200 may be performed by a wireless communication device, such as the wireless communication device 1600 described with reference to FIG. 16, operating as or within a wireless AP. In some examples, the process 2200 may be performed by a wireless AP, such as one of the APs 102 described with reference to FIG. 1.

In some examples, in 2205, the first access point may identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. The operations of 2205 may be performed in accordance with examples as disclosed herein. In some implementations, aspects of the operations of 2205 may be performed by a transmission mode identification component 1625 as described with reference to FIG. 16.

In some examples, in 2210, the first access point may transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, where the first set of bits includes a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits. The operations of 2210 may be performed in accordance with examples as disclosed herein. In some implementations, aspects of the operations of 2210 may be performed by a transmission mode indication component 1630 as described with reference to FIG. 16.

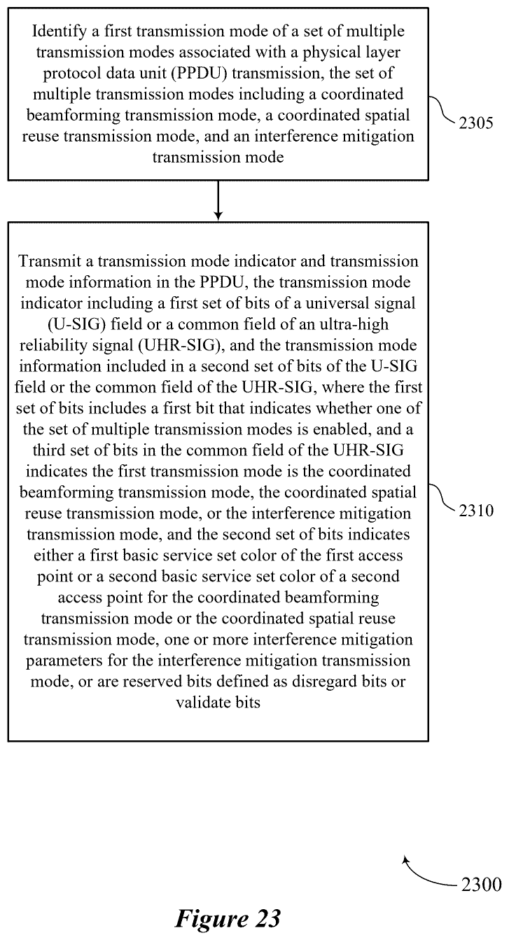

FIG. 23 shows a flowchart illustrating an example process 2300 performable by or at a first access point that supports signaling for transmission modes among access points. The operations of the process 2300 may be implemented by a first access point or its components as described herein. For example, the process 2300 may be performed by a wireless communication device, such as the wireless communication device 1600 described with reference to FIG. 16, operating as or within a wireless AP. In some examples, the process 2300 may be performed by a wireless AP, such as one of the APs 102 described with reference to FIG. 1.

In some examples, in 2305, the first access point may identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. The operations of 2305 may be performed in accordance with examples as disclosed herein. In some implementations, aspects of the operations of 2305 may be performed by a transmission mode identification component 1625 as described with reference to FIG. 16.

In some examples, in 2310, the first access point may transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, where the first set of bits includes a first bit that indicates whether one of the set of multiple transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits. The operations of 2310 may be performed in accordance with examples as disclosed herein. In some implementations, aspects of the operations of 2310 may be performed by a transmission mode indication component 1630 as described with reference to FIG. 16.

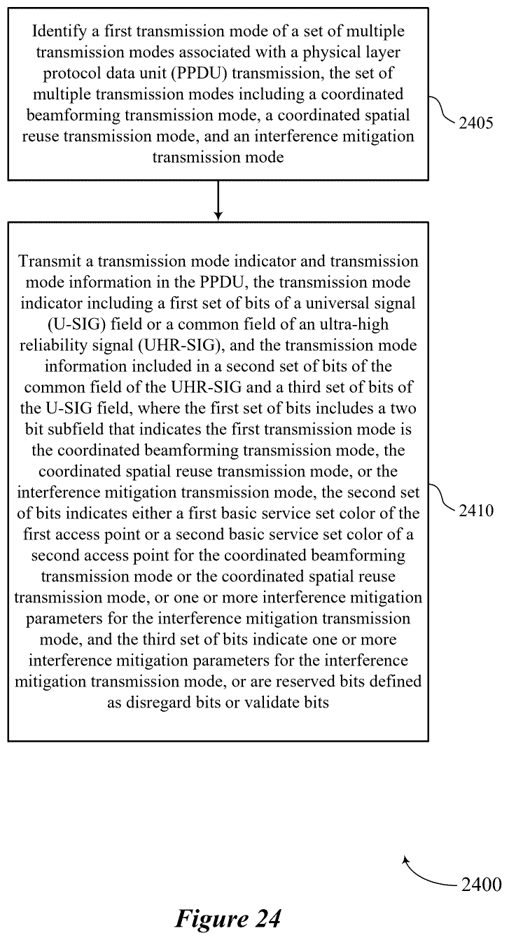

FIG. 24 shows a flowchart illustrating an example process 2400 performable by or at a first access point that supports signaling for transmission modes among access points. The operations of the process 2400 may be implemented by a first access point or its components as described herein. For example, the process 2400 may be performed by a wireless communication device, such as the wireless communication device 1600 described with reference to FIG. 16, operating as or within a wireless AP. In some examples, the process 2400 may be performed by a wireless AP, such as one of the APs 102 described with reference to FIG. 1.

In some examples, in 2405, the first access point may identify a first transmission mode of a set of multiple transmission modes associated with a physical layer protocol data unit (PPDU) transmission, the set of multiple transmission modes including a coordinated beamforming transmission mode, a coordinated spatial reuse transmission mode, and an interference mitigation transmission mode. The operations of 2405 may be performed in accordance with examples as disclosed herein. In some implementations, aspects of the operations of 2405 may be performed by a transmission mode identification component 1625 as described with reference to FIG. 16.

In some examples, in 2410, the first access point may transmit a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, where the first set of bits includes a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits. The operations of 2410 may be performed in accordance with examples as disclosed herein. In some implementations, aspects of the operations of 2410 may be performed by a transmission mode indication component 1630 as described with reference to FIG. 16.

Implementation examples are described in the following numbered clauses:

The following provides an overview of clauses of the present disclosure:

Clause 1: A method for wireless communications at a first access point, comprising: identifying a first transmission mode of a plurality of transmission modes associated with a physical layer protocol data unit (PPDU) transmission, the plurality of transmission modes comprising two or more of a coordinated beamforming transmission mode, a coordinated spatial reuse transmission mode, or an interference mitigation transmission mode; and transmitting first information in at least one of a first set of bits of a universal signal (U-SIG) field or one or more bits of a common field of an ultra-high reliability signal (UHR-SIG) of the PPDU, the first information indicating the first transmission mode of the plurality of transmission modes.

Clause 2: The method of clause 1, wherein the first set of bits of the U-SIG field comprises a one bit subfield that indicates whether the first transmission mode is the coordinated beamforming transmission mode in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or the first set of bits indicates whether the first transmission mode is the interference mitigation transmission mode in accordance with the PPDU Type And Compression Mode field that indicates a transmission to a single user, and wherein a second set of bits of the U-SIG field indicates either a first basic service set color of the first access point or a second basic service set color of a second access point for the coordinated beamforming transmission mode, or one or more interference mitigation parameters for the interference mitigation transmission mode, or reserved bits defined as disregard bits or validate bits.

Clause 3: The method of any of clauses 1 through 2, wherein the first set of bits of the U-SIG field comprises a first bit, and different combinations of bit values of the first bit and a second bit in the U-SIG field or in the common field of the UHR-SIG indicates the first transmission mode is the coordinated beamforming transmission mode, the coordinated spatial reuse transmission mode, or the interference mitigation transmission mode, and a second set of bits of the U-SIG field, or one or more bits of the common field of the UHR-SIG, indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

Clause 4: The method of any of clauses 1 through 3, wherein the first set of bits of the U-SIG field, or two bits of the common field of the UHR-SIG, comprises a two bit subfield that indicates the first transmission mode is the coordinated beamforming transmission mode, the coordinated spatial reuse transmission mode, or the interference mitigation transmission mode, and wherein a second set of bits of the U-SIG field or the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Clause 5: The method of any of clauses 1 through 4, wherein the first set of bits of the U-SIG field comprises a first bit that indicates whether one of the plurality of transmission modes is enabled, and a second set of bits in the common field of the UHR-SIG indicates the first transmission mode is the coordinated beamforming transmission mode, the coordinated spatial reuse transmission mode, or the interference mitigation transmission mode, and a third set of bits of the U-SIG field or the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Clause 6: The method of any of clauses 1 through 5, wherein the first set of bits of the U-SIG field comprises a two bit subfield that indicates the first transmission mode is the coordinated beamforming transmission mode, the coordinated spatial reuse transmission mode, or the interference mitigation transmission mode, and a second set of bits of the common field of the UHR-SIG indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Clause 7: The method of any of clauses 1 through 6, wherein the first set of bits of the U-SIG field comprises first bit that indicates whether a coordinated transmission scheme is used and second bit that indicates whether coordinated beamforming or coordinated spatial reuse is used when the first bit indicates the coordinated transmission scheme, and a second set of bits of the U-SIG field indicates either a first basic service set color of the first access point or a second basic service set color of a second access point for the coordinated beamforming or coordinated spatial reuse transmission mode, or an interference mitigation indication and one or more interference mitigation parameters for the interference mitigation transmission mode if the first bit does not indicate the coordinated transmission scheme, or the second set of bits of the U-SIG field are reserved bits defined as disregard bits or validate bits.

Clause 8: The method of any of clauses 1 through 7, wherein the first set of bits of the U-SIG field comprises a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user transmission mode with coordinated spatial reuse, or a single user transmission mode with interference mitigation, and a second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

Clause 9: The method of any of clauses 1 through 8, further comprising: transmitting, in accordance with the first transmission mode being a vendor specific transmission mode, at least one of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within the common field of an ultra-high reliability signal (UHR-SIG) field, or a vendor specific information using one or more bits of subfields within a user field of the UHR-SIG field.

Clause 10: A method for wireless communications at a first access point, comprising: identifying a first transmission mode of a plurality of transmission modes associated with a physical layer protocol data unit (PPDU) transmission, the first transmission mode comprising a coordinated beamforming transmission mode or an interference mitigation transmission mode; and transmitting a transmission mode indicator in the PPDU, the transmission mode indicator including a first set of bits of a universal signal (U-SIG) field of the PPDU, and transmission mode information in a second set of bits of the U-SIG field, wherein the transmission mode indicator indicates the first transmission mode, and is a one bit subfield that indicates whether the coordinated beamforming transmission mode is enabled or disabled in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, or whether the interference mitigation transmission mode is enabled or disabled in accordance with the PPDU Type And Compression Mode field indication of a transmission to a single user, and the transmission mode information indicates either a first basic service set color of the first access point or a second basic service set color of a second access point for the coordinated beamforming transmission mode, or one or more interference mitigation parameters for the interference mitigation transmission mode.

Clause 11: The method of clause 10, wherein at least one of a single bit to indicate interference mitigation is enabled or disabled, or the one or more interference mitigation parameters, are indicated in a first portion of the U-SIG field (U-SIG-1) using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

Clause 12: The method of any of clauses 10 through 11, wherein a vendor specific transmission mode is indicated using a one bit indicator in the U-SIG field or a common field of an ultra-high reliability signal (UHR-SIG) that is different from the transmission mode indicator.

Clause 13: The method of clause 12, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Clause 14: A method for wireless communications at a first access point, comprising: identifying a first transmission mode of a plurality of transmission modes associated with a physical layer protocol data unit (PPDU) transmission, the plurality of transmission modes comprising two or more of a coordinated beamforming transmission mode, a coordinated spatial reuse transmission mode, an interference mitigation transmission mode, or a vendor specific transmission mode; and transmitting a transmission mode indicator in the PPDU, the transmission mode indicator including a first bit and a second bit of a universal signal (U-SIG) field and transmission mode information in a subfield of the U-SIG field, wherein the transmission mode indicator indicates the first transmission mode, and the transmission mode information indicates either a first basic service set color of the first access point or a second basic service set color of a second access point for the coordinated beamforming transmission mode or the coordinated spatial reuse transmission mode, or one or more interference mitigation parameters for the interference mitigation transmission mode.

Clause 15: The method of clause 14, wherein the first bit of the U-SIG field indicates whether the coordinated beamforming transmission mode is enabled or disabled for non-orthogonal frequency division multiple access (non-OFDMA) multi-user (MU) multiple-input multiple-output (MIMO) communications or OFDMA communications, or whether the coordinated spatial reuse transmission mode is enabled or disabled for single-user (SU) communications.

Clause 16: The method of any of clauses 14 through 15, wherein at least one of the second bit of the U-SIG field, or one bit within a first portion of the U-SIG field (U-SIG-1) indicates whether the interference mitigation transmission mode is enabled or disabled, and when the interference mitigation transmission mode is enabled, the one or more interference mitigation parameters are indicated in the U-SIG-1 using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

Clause 17: The method of any of clauses 14 through 16, wherein the vendor specific transmission mode is indicated using a one bit indicator in the U-SIG field or a common field of an ultra-high reliability signal (UHR-SIG) that is different from the transmission mode indicator.

Clause 18: The method of any of clauses 14 through 17, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, vendor specific information using one or more bits within a common field of an ultra-high reliability signal (UHR-SIG), or a vendor specific information using one or more bits of subfields within a user field of an ultra-high reliability signal (UHR-SIG).

Clause 19: A method for wireless communications at a first access point, comprising: identifying a first transmission mode of a plurality of transmission modes associated with a physical layer protocol data unit (PPDU) transmission, the plurality of transmission modes comprising a coordinated beamforming transmission mode, a coordinated spatial reuse transmission mode, and an interference mitigation transmission mode; and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, wherein the first set of bits comprises a two bit subfield that indicates the first transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Clause 20: The method of clause 19, wherein a first bit value of the first set of bits indicates that one or more advanced features for communications are disabled, a second bit value of the first set of bits indicates that the coordinated beamforming transmission mode is enabled, a third bit value of the first set of bits indicates that the coordinated spatial reuse transmission mode is enabled, and a fourth bit value of the first set of bits indicates that the interference mitigation transmission mode is enabled.

Clause 21: The method of any of clauses 19 through 20, wherein the one or more interference mitigation parameters are indicated in a first portion of the U-SIG field (U-SIG-1) using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

Clause 22: The method of any of clauses 19 through 21, wherein a vendor specific transmission mode is indicated using a one bit indicator in the U-SIG field, or a common field of an ultra-high reliability signal (UHR-SIG), that is different from the transmission mode indicator.

Clause 23: The method of clause 22, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within an ultra-high reliability signal (UHR-SIG) common field, or a vendor specific information using one or more bits of subfields within a user field of the UHR-SIG field.

Clause 24: A method for wireless communications at a first access point, comprising: identifying a first transmission mode of a plurality of transmission modes associated with a physical layer protocol data unit (PPDU) transmission, the plurality of transmission modes comprising a coordinated beamforming transmission mode, a coordinated spatial reuse transmission mode, and an interference mitigation transmission mode; and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, wherein the first set of bits comprises first bit that indicates whether a coordinated transmission scheme is used and second bit that indicates whether coordinated beamforming or coordinated spatial reuse is used when the first bit indicates the coordinated transmission scheme, and the second set of bits indicates either a first basic service set color of the first access point or a basic service set color of a second access point for the coordinated beamforming or coordinated spatial reuse transmission mode, an interference mitigation indication and one or more interference mitigation parameters for the interference mitigation transmission mode if the first bit does not indicate the coordinated transmission scheme, or are reserved bits defined as disregard bits or validate bits.

Clause 25: The method of clause 24, wherein the one or more interference mitigation parameters are indicated in a first portion of the U-SIG field (U-SIG-1).

Clause 26: The method of any of clauses 24 through 25, wherein a vendor specific transmission mode is indicated using a one bit indicator in the U-SIG field, or the common field of the UHR-SIG, that is different from the first set of bits.

Clause 27: The method of clause 26, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within an ultra-high reliability signal (UHR-SIG) common field, or a vendor specific information using one or more bits of subfields within a user field of the UHR-SIG field.

Clause 28: A method for wireless communications at a first access point, comprising: identifying a first transmission mode of a plurality of transmission modes associated with a physical layer protocol data unit (PPDU) transmission, the plurality of transmission modes comprising a coordinated beamforming transmission mode, a coordinated spatial reuse transmission mode, and an interference mitigation transmission mode; and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field, wherein the first set of bits comprises a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user coordinated spatial reuse transmission mode, or the interference mitigation transmission mode, and the second set of bits of the U-SIG field indicates either a first basic service set color of the first access point or a second basic service set color of a second access point for the coordinated beamforming transmission mode or the coordinated spatial reuse transmission mode, or one or more interference mitigation parameters for the interference mitigation transmission mode, or are reserved bits defined as disregard bits or validate bits.

Clause 29: The method of clause 28, wherein a vendor specific transmission mode is indicated using a one bit indicator in the U-SIG field or a common field of an ultra-high reliability signal (UHR-SIG) that is different from the transmission mode indicator.

Clause 30: The method of clause 29, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Clause 31: A method for wireless communications at a first access point, comprising: identifying a first transmission mode of a plurality of transmission modes associated with a physical layer protocol data unit (PPDU) transmission, the plurality of transmission modes comprising a coordinated beamforming transmission mode, a coordinated spatial reuse transmission mode, and an interference mitigation transmission mode; and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the U-SIG field or the common field of the UHR-SIG, wherein the first set of bits comprises a first bit that indicates whether one of the plurality of transmission modes is enabled, and a third set of bits in the common field of the UHR-SIG indicates the first transmission mode is the coordinated beamforming transmission mode, the coordinated spatial reuse transmission mode, or the interference mitigation transmission mode, and the second set of bits indicates either a first basic service set color of the first access point or a second basic service set color of a second access point for the coordinated beamforming transmission mode or the coordinated spatial reuse transmission mode, one or more interference mitigation parameters for the interference mitigation transmission mode, or are reserved bits defined as disregard bits or validate bits.

Clause 32: The method of clause 31, wherein a vendor specific transmission mode is indicated using a one bit indicator in the U-SIG field or a common field of an ultra-high reliability signal (UHR-SIG) that is different from the transmission mode indicator.

Clause 33: The method of clause 32, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Clause 34: A method for wireless communications at a first access point, comprising: identifying a first transmission mode of a plurality of transmission modes associated with a physical layer protocol data unit (PPDU) transmission, the plurality of transmission modes comprising a coordinated beamforming transmission mode, a coordinated spatial reuse transmission mode, and an interference mitigation transmission mode; and transmitting a transmission mode indicator and transmission mode information in the PPDU, the transmission mode indicator including a first set of bits of a universal signal (U-SIG) field or a common field of an ultra-high reliability signal (UHR-SIG), and the transmission mode information included in a second set of bits of the common field of the UHR-SIG and a third set of bits of the U-SIG field, wherein the first set of bits comprises a two bit subfield that indicates the first transmission mode is the coordinated beamforming transmission mode, the coordinated spatial reuse transmission mode, or the interference mitigation transmission mode, the second set of bits indicates either a first basic service set color of the first access point or a second basic service set color of a second access point for the coordinated beamforming transmission mode or the coordinated spatial reuse transmission mode, or one or more interference mitigation parameters for the interference mitigation transmission mode, and the third set of bits indicate one or more interference mitigation parameters for the interference mitigation transmission mode, or are reserved bits defined as disregard bits or validate bits.

Clause 35: The method of clause 34, wherein a vendor specific transmission mode is indicated using a one bit indicator in the U-SIG field or a common field of an ultra-high reliability signal (UHR-SIG) that is different from the transmission mode indicator.

Clause 36: The method of clause 35, further comprising: transmitting, in accordance with the first transmission mode being the vendor specific transmission mode, one or more of a vendor specific field subsequent to the U-SIG field that indicates one or more vendor specific parameters, a vendor specific field within an ultra-high reliability signal (UHR-SIG) field that indicates one or more vendor specific parameters, a vendor specific information using one or more bits of subfields within a common field of an ultra-high reliability signal (UHR-SIG), or a vendor specific information using one or more bits of subfields within a user field of the UHR-SIG field.

Clause 37: A first access point for wireless communications, comprising one or more memories storing processor-executable code, and one or more processors coupled with the one or more memories and individually or collectively operable to execute the code to cause the first access point to perform a method of any of clauses 1 through 9.

Clause 38: A first access point for wireless communications, comprising at least one means for performing a method of any of clauses 1 through 9.

Clause 39: A non-transitory computer-readable medium storing code for wireless communications, the code comprising instructions executable by one or more processors to perform a method of any of clauses 1 through 9.

Clause 40: A first access point for wireless communications, comprising one or more memories storing processor-executable code, and one or more processors coupled with the one or more memories and individually or collectively operable to execute the code to cause the first access point to perform a method of any of clauses 10 through 13.

Clause 41: A first access point for wireless communications, comprising at least one means for performing a method of any of clauses 10 through 13.

Clause 42: A non-transitory computer-readable medium storing code for wireless communications, the code comprising instructions executable by one or more processors to perform a method of any of clauses 10 through 13.

Clause 43: A first access point for wireless communications, comprising one or more memories storing processor-executable code, and one or more processors coupled with the one or more memories and individually or collectively operable to execute the code to cause the first access point to perform a method of any of clauses 14 through 18.

Clause 44: A first access point for wireless communications, comprising at least one means for performing a method of any of clauses 14 through 18.

Clause 45: A non-transitory computer-readable medium storing code for wireless communications, the code comprising instructions executable by one or more processors to perform a method of any of clauses 14 through 18.

Clause 46: A first access point for wireless communications, comprising one or more memories storing processor-executable code, and one or more processors coupled with the one or more memories and individually or collectively operable to execute the code to cause the first access point to perform a method of any of clauses 19 through 23.

Clause 47: A first access point for wireless communications, comprising at least one means for performing a method of any of clauses 19 through 23.

Clause 48: A non-transitory computer-readable medium storing code for wireless communications, the code comprising instructions executable by one or more processors to perform a method of any of clauses 19 through 23.

Clause 49: A first access point for wireless communications, comprising one or more memories storing processor-executable code, and one or more processors coupled with the one or more memories and individually or collectively operable to execute the code to cause the first access point to perform a method of any of clauses 24 through 27.

Clause 50: A first access point for wireless communications, comprising at least one means for performing a method of any of clauses 24 through 27.

Clause 51: A non-transitory computer-readable medium storing code for wireless communications, the code comprising instructions executable by one or more processors to perform a method of any of clauses 24 through 27.

Clause 52: A first access point for wireless communications, comprising one or more memories storing processor-executable code, and one or more processors coupled with the one or more memories and individually or collectively operable to execute the code to cause the first access point to perform a method of any of clauses 28 through 30.

Clause 53: A first access point for wireless communications, comprising at least one means for performing a method of any of clauses 28 through 30.

Clause 54: A non-transitory computer-readable medium storing code for wireless communications, the code comprising instructions executable by one or more processors to perform a method of any of clauses 28 through 30.

Clause 55: A first access point for wireless communications, comprising one or more memories storing processor-executable code, and one or more processors coupled with the one or more memories and individually or collectively operable to execute the code to cause the first access point to perform a method of any of clauses 31 through 33.

Clause 56: A first access point for wireless communications, comprising at least one means for performing a method of any of clauses 31 through 33.

Clause 57: A non-transitory computer-readable medium storing code for wireless communications, the code comprising instructions executable by one or more processors to perform a method of any of clauses 31 through 33.

Clause 58: A first access point for wireless communications, comprising one or more memories storing processor-executable code, and one or more processors coupled with the one or more memories and individually or collectively operable to execute the code to cause the first access point to perform a method of any of clauses 34 through 36.

Clause 59: A first access point for wireless communications, comprising at least one means for performing a method of any of clauses 34 through 36.

Clause 60: A non-transitory computer-readable medium storing code for wireless communications, the code comprising instructions executable by one or more processors to perform a method of any of clauses 34 through 36.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a”and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communications at a first access point, comprising:
identifying a first transmission mode of a plurality of transmission modes associated with a physical layer protocol data unit (PPDU) transmission, the plurality of transmission modes comprising a coordinated beamforming transmission mode and a coordinated spatial reuse transmission mode; and
transmitting first information in at least one of a first set of bits of a universal signal (U-SIG) field or one or more bits of a common field of an ultra-high reliability signal (UHR-SIG) of the PPDU, the first information indicating the first transmission mode of the plurality of transmission modes.

2. The method of claim 1, wherein:
the first set of bits of the U-SIG field comprises a first bit, and different combinations of bit values of the first bit and bit values of two bits of a PPDU Type And Compression Mode field jointly indicate the first transmission mode is the coordinated beamforming transmission mode or the coordinated spatial reuse transmission mode.

3. The method of claim 2, wherein:
the U-SIG field comprises a U-SIG-1 field and a U-SIG-2 field, and the first bit is bit B2 of the U-SIG-2 field.

4. The method of claim 3, wherein:
when an uplink/downlink bit in the U-SIG field has a first value and the PPDU Type And Compression Mode field has a first value, the first bit indicates either a single user transmission mode or the coordinated spatial reuse transmission mode.

5. The method of claim 3, wherein:
when an uplink/downlink bit in the U-SIG field has a first value and the PPDU Type And Compression Mode field has a second value, the first bit indicates either a non-orthogonal frequency division multiple access (OFDMA) multi-user (MU) multiple-input-multiple-output (MIMO) transmission mode or the coordinated beamforming transmission mode.

6. The method of claim 1, wherein:
the first set of bits of the U-SIG field, or two bits of the common field of the UHR-SIG, comprises a two bit subfield that indicates the first transmission mode is the coordinated beamforming transmission mode or the coordinated spatial reuse transmission mode, and wherein a second set of bits of the U-SIG field or the common field of the UHR-SIG indicates either a first basic service set color of the first access point or a second basic service set color of a second access point for the coordinated beamforming transmission mode or the coordinated spatial reuse transmission mode, or are reserved bits defined as disregard bits or validate bits.

7. The method of claim 1, wherein:
the first set of bits of the U-SIG field comprises a first bit that indicates whether one of the plurality of transmission modes is enabled, and a second set of bits in the common field of the UHR-SIG indicates the first transmission mode is the coordinated beamforming transmission mode or the coordinated spatial reuse transmission mode, and
a third set of bits of the U-SIG field or the common field of the UHR-SIG indicates either a first basic service set color of the first access point or a second basic service set color of a second access point for the coordinated beamforming transmission mode or the coordinated spatial reuse transmission mode, or are reserved bits defined as disregard bits or validate bits.

8. The method of claim 1, wherein:
the first set of bits of the U-SIG field comprises first bit that indicates whether a coordinated transmission scheme is used and second bit that indicates whether coordinated beamforming or coordinated spatial reuse is used when the first bit indicates the coordinated transmission scheme, and a second set of bits of the U-SIG field indicates either a first basic service set color of the first access point or a second basic service set color of a second access point for the coordinated beamforming or coordinated spatial reuse transmission mode, or the second set of bits of the U-SIG field are reserved bits defined as disregard bits or validate bits.

9. The method of claim 1, wherein:
the first set of bits of the U-SIG field comprises a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user transmission mode with coordinated spatial reuse, or a single user transmission mode with interference mitigation, and
a second set of bits of the U-SIG field indicates either a first basic service set color of the first access point or a second basic service set color of a second access point for the coordinated beamforming transmission mode or the coordinated spatial reuse transmission mode, or one or more interference mitigation parameters for an interference mitigation transmission mode, or are reserved bits defined as disregard bits or validate bits.

10. A method for wireless communications at a first access point, comprising:
identifying a first transmission mode of a plurality of transmission modes associated with a physical layer protocol data unit (PPDU) transmission, the plurality of transmission modes comprising a coordinated beamforming transmission mode and a coordinated spatial reuse transmission mode; and
transmitting a transmission mode indicator in the PPDU, the transmission mode indicator including a first bit and a second bit of a universal signal (U-SIG) field and transmission mode information in a subfield of the U-SIG field, wherein:
the transmission mode indicator indicates the first transmission mode, and
the transmission mode information indicates either a first basic service set color of the first access point or a second basic service set color of a second access point for the coordinated beamforming transmission mode or the coordinated spatial reuse transmission mode.

11. The method of claim 10, wherein:
the first bit of the U-SIG field indicates whether the coordinated beamforming transmission mode is enabled or disabled for non-orthogonal frequency division multiple access (non-OFDMA) multi-user (MU) multiple-input multiple-output (MIMO) communications or OFDMA communications, or whether the coordinated spatial reuse transmission mode is enabled or disabled for single-user (SU) communications.

12. The method of claim 10, wherein:
at least one of the second bit of the U-SIG field, or one bit within a first portion of the U-SIG field (U-SIG-1) indicates whether an interference mitigation transmission mode is enabled or disabled, and
when the interference mitigation transmission mode is enabled, one or more interference mitigation parameters are indicated in the U-SIG-1 using one or more disregard bits or validate bits, using one or more repurposed bits of a second portion of the U-SIG field (U-SIG-2), or using one or more disregard bits or repurposed bits of a common field of an ultra-high reliability signal (UHR-SIG).

13. An apparatus for wireless communication at a first access point, comprising:
a processing system that includes processor circuitry and memory circuitry that stores code, the processing system configured to cause the first access point to:
identify a first transmission mode of a plurality of transmission modes associated with a physical layer protocol data unit (PPDU) transmission, the plurality of transmission modes comprising a coordinated beamforming transmission mode and a coordinated spatial reuse transmission mode; and
transmit first information in at least one of a first set of bits of a universal signal (U-SIG) field or one or more bits of a common field of an ultra-high reliability signal (UHR-SIG) of the PPDU, the first information indicating the first transmission mode of the plurality of transmission modes.

14. The apparatus of claim 13, wherein the first set of bits of the U-SIG field comprises a one bit subfield that indicates whether the first transmission mode is the coordinated beamforming transmission mode in accordance with an uplink/downlink bit and a PPDU Type And Compression Mode field that jointly indicate a non-orthogonal frequency division multiple access (OFDMA) multi-user (MU) multiple-input-multiple-output (MIMO) transmission or an OFDMA transmission, and wherein a second set of bits of the U-SIG field indicates either a first basic service set color of the first access point or a second basic service set color of a second access point for the coordinated beamforming transmission mode, or reserved bits defined as disregard bits or validate bits.

15. The apparatus of claim 13, wherein the first set of bits of the U-SIG field comprises a first bit, and different combinations of bit values of the first bit and a second bit in the U-SIG field or in the common field of the UHR-SIG indicates the first transmission mode is the coordinated beamforming transmission mode or the coordinated spatial reuse transmission mode, and a second set of bits of the U-SIG field, or one or more bits of the common field of the UHR-SIG, indicates either a first basic service set color of the first access point or a second basic service set color of a second access point for the coordinated beamforming transmission mode or the coordinated spatial reuse transmission mode, or are reserved bits defined as disregard bits or validate bits.

16. The apparatus of claim 13, wherein the first set of bits of the U-SIG field, or two bits of the common field of the UHR-SIG, comprises a two bit subfield that indicates the first transmission mode is the coordinated beamforming transmission mode or the coordinated spatial reuse transmission mode, and wherein a second set of bits of the U-SIG field or the common field of the UHR-SIG indicates either a first basic service set color of the first access point or a second basic service set color of a second access point for the coordinated beamforming transmission mode or the coordinated spatial reuse transmission mode, or are reserved bits defined as disregard bits or validate bits.

17. The apparatus of claim 13, wherein the first set of bits of the U-SIG field comprises a first bit that indicates whether one of the plurality of transmission modes is enabled, and a second set of bits in the common field of the UHR-SIG indicates the first transmission mode is the coordinated beamforming transmission mode or the coordinated spatial reuse transmission mode, and a third set of bits of the U-SIG field or the common field of the UHR-SIG indicates either a first basic service set color of the first access point or a second basic service set color of a second access point for the coordinated beamforming transmission mode or the coordinated spatial reuse transmission mode, or are reserved bits defined as disregard bits or validate bits.

18. The apparatus of claim 13, wherein the first set of bits of the U-SIG field comprises a two bit subfield that indicates the first transmission mode is the coordinated beamforming transmission mode or the coordinated spatial reuse transmission mode, and a second set of bits of the common field of the UHR-SIG indicates either a first basic service set color of the first access point or a second basic service set color of a second access point for the coordinated beamforming transmission mode or the coordinated spatial reuse transmission mode, or are reserved bits defined as disregard bits or validate bits.

19. The apparatus of claim 13, wherein the first set of bits of the U-SIG field comprises first bit that indicates whether a coordinated transmission scheme is used and second bit that indicates whether coordinated beamforming or coordinated spatial reuse is used when the first bit indicates the coordinated transmission scheme, and a second set of bits of the U-SIG field indicates either a first basic service set color of the first access point or a second basic service set color of a second access point for the coordinated beamforming or coordinated spatial reuse transmission mode, or the second set of bits of the U-SIG field are reserved bits defined as disregard bits or validate bits.

20. The apparatus of claim 13, wherein the first set of bits of the U-SIG field comprises a first bit that indicates whether a physical layer protocol data unit (PPDU) type and compression mode field is to be interpreted to indicate a transmission mode for the PPDU, where a first value of the first bit indicates that the PPDU type and compression mode field is to be interpreted according to a first interpretation that indicates an enhanced long range (ELR) transmission mode, and a second value of the first bit indicates that the PPDU type and compression mode field is to be interpreted to indicate one or more of a non-orthogonal frequency division multiple access coordinated beamforming transmission mode, a single user transmission mode with coordinated spatial reuse, or a single user transmission mode with interference mitigation, and a second set of bits of the U-SIG field indicates either a first basic service set color of the first access point or a second basic service set color of a second access point for the coordinated beamforming transmission mode or the coordinated spatial reuse transmission mode, or are reserved bits defined as disregard bits or validate bits.
